(19) United States
(12) Patent Application Publication
(10) Pub. No.: US 2013/0166614 A1
(43) Pub. Date: Jun. 27, 2013

(54) COMPUTER SYSTEM, FILE MANAGEMENT METHOD, AND STORAGE MEDIUM

(71) Applicants: Yuuki Watanabe, Yokohama (JP); Takuya Okamoto, Machida (JP); Hiroshi Nojima, Fujisawa (JP)

(72) Inventors: Yuuki Watanabe, Yokohama (JP); Takuya Okamoto, Machida (JP); Hiroshi Nojima, Fujisawa (JP)

(73) Assignee: HITACHI, LTD., Tokyo (JP)

(21) Appl. No.: 13/395,501

(22) PCT Filed: Dec. 27, 2011
(86) PCT No.: PCT/JP2011/080290

§ 371 Date: Mar. 12, 2012

(51) Int. Cl. G06F 17/30

(52) U.S. Cl. 707/830; 707/831; 707/E17.01

(57) ABSTRACT

A computer system of an embodiment includes a processor and a storage device for managing real file systems and a virtual file system virtualizing the real file systems to control relocation of a file in the virtual file system. Volumes different in access performance provided by a storage system are assigned to the real file systems belonging to tiers different in access performance. The storage device stores file usage state information representing usage states of files in the virtual file system and storage usage state information representing a usage state of the storage system. The processor generates control information associating characteristics of files with evaluation values of the tiers using the two pieces of information and determines an evaluation value for each of one or more relocation destination tier candidates of a first file in the virtual file system based a characteristic of the first file and the control information.

### BACKGROUND

This invention relates to a computer system, a file management method, and a storage medium, and more particularly, to allocation control for a file.

There is known a technology for virtualizing a plurality of real file systems, and managing the plurality of real file systems by means of a single virtual file system on a file server. Moreover, there is a known technology for carrying out tier management on a file system level by assigning different real file systems to storage volumes different in performance, thereby virtualizing the real file systems. Patent literature 1 discloses a technology for carrying out data allocation in accordance with a policy of a user in an environment in which a plurality of storage systems are mixed.

As described above, the system for managing the file allocation on a file server carries out the allocation control per file. The control for allocating a file in a tiered real file system is carried out based on an operation policy specified by a user. The operation policy specifies a condition representing an information value of a file, and an allocation destination of the file for the condition.

### CITATION LIST

Patent literature 1: JP2011-90714A

### SUMMARY

If the operation policy can be adjusted in the system carrying out the file allocation in accordance with the operation policy as described above, a better file allocation can be carried out. Moreover, it is important that the operation policy can be adjusted based on a usage state of the storage system in order to efficiently use a storage volume (volume) of the storage system tiered based on performance.

However, it is difficult for the user to keep adjusting the operation policy following the state of the storage system changing day by day. Therefore, file allocation control for efficiently using the storage system cannot be carried out.

An aspect of this invention is a computer system comprising a processor and a storage device for managing a plurality of real file systems and a virtual file system virtualizing the plurality of real file systems to control relocation of a file in the virtual file system, a plurality of volumes different in access performance provided by a storage system being assigned to the plurality of real file systems, the plurality of real file systems belonging to a plurality of tiers different in access performance. The storage device stores file usage state information representing usage states of a plurality of files in the virtual file system. The storage device stores storage usage state information representing a usage state of the storage system. The processor generates control information for associating characteristics of files with evaluation values of the plurality of tiers using the file usage state information and the storage usage state information. The processor determines an evaluation value for each of one or more relocation destination tier candidates of a first file in the virtual file system based a characteristic of the first file and the control information.

According to the aspect of this invention, in the system for managing the real file systems tiered based on the access performance and the virtual file system for virtualizing the tired real file systems, the tier candidates of the relocation destination of the file can be more properly evaluated.

### BRIEF DESCRIPTION OF THE DRAWINGS

In the accompanying drawings:

FIG. 1 schematically illustrates a configuration of a computer system according to an embodiment;

FIG. 2 illustrates a file system configuration example provided by a file server and a storage system, and a relationship between volumes and file systems according to this embodiment;

FIG. 3 illustrates a flow of file relocation control processing for the computer system according to this embodiment;

FIG. 4 illustrates a configuration example of an operation policy table of the file server according to this embodiment;

FIG. 5 illustrates a configuration example of a file usage state table of the file server according to this embodiment;

FIG. 6 illustrates a flow of file relocation processing according to a comparative example to this embodiment;

FIG. 7 illustrates a result of determination processing for file relocation destinations according to the flow of FIG. 6;

FIG. 8 illustrates a configuration example of a storage usage state table according to this embodiment;

FIG. 9 illustrates a configuration example of a file allocation management table of the file server according to this embodiment;

FIG. 10 illustrates a flow of update processing for a relocation control table according to this embodiment;

FIG. 11 illustrates an example of a calculation result of file attributes output in Step S303 of FIG. 10;

FIG. 12 illustrates an example of a calculation result of an operation efficiency E calculated in Step S304 of FIG. 10;

FIG. 13 illustrates a flow in Step S305 of FIG. 10;

FIG. 14 illustrates an example of a calculation result of operation efficiency coefficients according to this embodiment;

FIG. 15 illustrates an example of a weight parameter table according to this embodiment;

FIG. 16 illustrates a calculation result of evaluation values of tiers according to this embodiment;

FIG. 17 illustrates an example of the relocation control table according to this embodiment;

FIG. 18 illustrates a flow of file relocation execution processing according to this embodiment;

FIG. 19 illustrates a calculation result (intermediate calculation result) in the course of the flow of FIG. 18;

FIG. 20 illustrates an example of a relocation subject file selection image on a display apparatus of a management terminal according to this embodiment;

FIG. 21 illustrates details of determination in Step S504 of FIG. 18;

FIG. 22A illustrates an example of the file usage state table after a file relocation according to this embodiment;

FIG. 22B illustrates an example of the storage usage state table after the file relocation according to this embodiment;

FIG. 22C illustrates an example of a calculation result of the operation efficiency E after the file relocation according to this embodiment;

FIG. 23 illustrates a display example of a file/storage usage state chart according to this embodiment;

FIG. 24 illustrates a method of inputting a feedback by an administrator to information displayed in the file/storage usage state chart according to this embodiment;

FIG. 25 illustrates a flow of a feedback to weight parameters based on a change in a capacity usage rate of a drive by the administrator on the management terminal according to this embodiment;

FIG. 26A illustrates an example of a feedback input value for a drive usage rate by the administrator according to this embodiment;

FIG. 26B illustrates an example of feedback calculation parameters according to this embodiment;

FIG. 26C illustrates an example of a parameter table to which a user feedback is reflected according to this embodiment;

FIG. 27 illustrates a flow of feedback processing for a change in a file allocation list according to this embodiment;

FIG. 28A is a calculation progress diagram in the flow of FIG. 27; and

FIG. 28B is a calculation progress diagram in the flow of FIG. 27.

### DETAILED DESCRIPTION OF THE PREFERRED EMBODIMENT

A description is now given of an embodiment of this invention. The following description and drawings are properly omitted and simplified for the sake of clarification of the description. Moreover, in the drawings, the same components are denoted by the same numerals, and redundant description is omitted as necessary for the sake of clear description.

A computer system according to the embodiment of this invention includes a storage system and a file server computer. The storage system provides volumes tiered based on performance. The tiered volumes are assigned to the file server computer, and the file server computer manages real file systems similarly tiered based on performance and a virtual file system virtualizing the real file systems.

The computer system according to this embodiment monitors a usage state of the storage system and usage states of files, and calculates an operation efficiency of the system from these pieces of information. The operation efficiency is an index representing a performance of files and a usage efficiency of the storage system. The computer system generates control information for relocating a file so as to increase the operation efficiency. The computer system evaluates relocation destination tier candidates for the file based on the generated control information. As a result, a more appropriate tier can be selected as the relocation destination of the file.

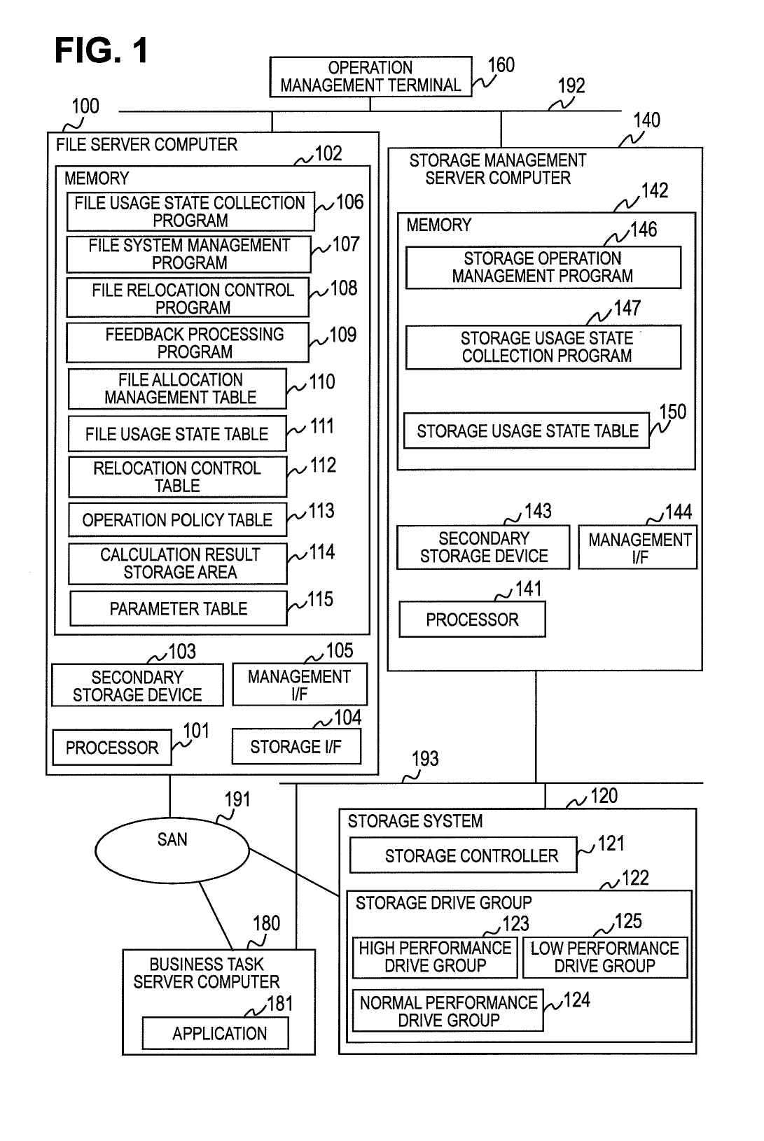

FIG. 1 schematically illustrates a configuration of the computer system according to this embodiment. The computer system according to this embodiment includes a file server computer 100 (hereinafter, sometimes referred to as file server), a storage system 120, a storage management server computer 140 (hereinafter, sometimes referred to as storage management server), a management terminal 160, and a business task server computer 180 (hereinafter, sometimes referred to business task server). The numbers of the various types of apparatus in the system depend on the design.

The file server 100, the storage system 120, and the business task server 180 are coupled to each other via a data network 191. The data network 191 is a network for data communication, and is a storage area network (SAN) according to this configuration. The data network 191 may be a network other than the SAN as long as the data network 191 is a network for data communication, and may be an IP network, for example.

A business task application program (sometimes referred to as application) 181 is running on the business task server 180. The business task server 180 is coupled to the file server 100 via the SAN 191, and the business task application program 181 on the business task server 180 makes access to the file server 100, and reads/writes data, thereby carrying out a business task. The file server 100 makes access to a volume on each storage drive of the storage system 120, thereby transmitting/receiving data.

The management terminal 160 is coupled to the file server 100 and the storage management server 140 via a management network 192. Moreover, the storage system 120, the storage management server 140, and the business task server 180 are coupled to each other via a management network 193. An administrator can operate programs provided by the file server 100 and the storage management server 140 using the management terminal 160. The management networks 192 and 193 are typically IP networks, and may be networks of a different type.

The storage system 120 includes a storage controller 121 and a storage drive group 122. The storage drive group 122 includes a high performance drive group 123, a normal performance drive group 124, and a low performance drive group 125. An example of the high performance drive is a solid state drive (SSD).

Examples of the normal performance drive and the low performance drive are a serial attached SCSI hard disk drive (SAS HDD) and a serial ATA hard disk drive (SATA HDD). The storage system 120 can provide volumes different in access performance using the different types of drive. The volume is a logical storage volume.

The file server 100 includes a processor 101, a memory 102, a non-volatile secondary storage device 103, a storage I/F 104, and a management I/F 105, and each of the components is coupled to each other. The processor 101 operates in accordance with a program stored in the memory 102. Programs and data (including tables) stored in the secondary storage device 103 are loaded to the memory 102.

The storage I/F 104 is a network interface to be coupled to the SAN 191. The storage I/F 104 transmits/receives data and control instructions to/from the storage system 120 via the SAN 191. The management I/F 105 is a network interface to be coupled to the management network 192. The management I/F 105 transmits/receives management data and control instructions to/from the management terminal 160 and the storage management server 140 via the management network 192.

The memory 102 stores a file usage state collection program 106, a file system management program 107, a file relocation control program 108, and a feedback processing program 109. The memory 102 further stores a file allocation management table 110, a file usage state table 111, a relocation control table 112, an operation policy table 113, and a parameter table 115. The memory 102 further includes a calculation result storage area 114.

The file usage state collection program 106 collects attributes and a usage state of each of the files on the file server 100, and stores the attributes and the usage state in the file usage state table 111. The file system management program 107 is a program for executing a file system virtualization management function, and relocates files based on relocation control information stored in the relocation control table 112.

The file relocation control program 108 cooperates with the storage management server 140 to generate the relocation control information to be stored in the relocation control table 112 using information in the parameter table 115 and the operation policy table 113. The file relocation control program 108 generates the relocation control information so as to increase the operation efficiency. The operation policy table 113 stores an operation policy configured by a user to determine file relocation destination candidates.

The feedback processing program 109 receives a feedback by the administrator from a display screen for the usage state of the file server 100 and the usage state of the storage system 140, thereby updating parameters used for calculating the file relocation. Intermediate results in the calculation carried out by the program are stored in the calculation result storage area 114.

The storage management server 140 includes a processor 141, a memory 142, a non-volatile secondary storage device 143, and a management I/F 144, and each of the components is coupled to each other. The processor 141 operates in accordance with a program stored in the memory 142. Programs and data (including tables) stored in the secondary storage device 143 are loaded to the memory 142. The memory 142 stores a storage operation management program 146 and a storage usage state collection program 147. The memory 142 further stores a storage usage state table 150.

The storage operation management program 146 is a program for managing the storage system 120. The storage usage state collection program 147 makes access to the storage controller 121 of the storage system 120, thereby collecting the usage state of the storage system 120, and stores the usage state in the storage usage state table 150.

In FIG. 1, the programs and the tables are illustrated in the memory, which is a storage device, for the sake of description, but the programs and tables are typically loaded from a storage volume of the secondary storage device onto a storage volume of the memory. The secondary storage device is a storage device including a non-volatile, non-transitory storage medium for storing programs and data (including the above-mentioned tables) required for realizing predetermined functions. The secondary storage device may be an external storage device coupled via a network.

The program is executed by a processor, thereby carrying out specified processing using a storage device and a communication interface. Therefore, in to this embodiment, a description where the program is a subject word may be a description where the processor is a subject word. Alternatively, processing carried out by the program is processing carried out by an apparatus or a system on which the program is running.

The processor operates in accordance with a program, thereby operating as a functional part for realizing a predetermined function. For example, the processor 101 operates in accordance with the file usage state collection program 106, thereby functioning as a file usage state collection part, and the processor 141 operates in accordance with the storage operation management program 146, thereby functioning as storage operation management part. A device and a system containing a processor and a program are a device and a system containing these functional parts.

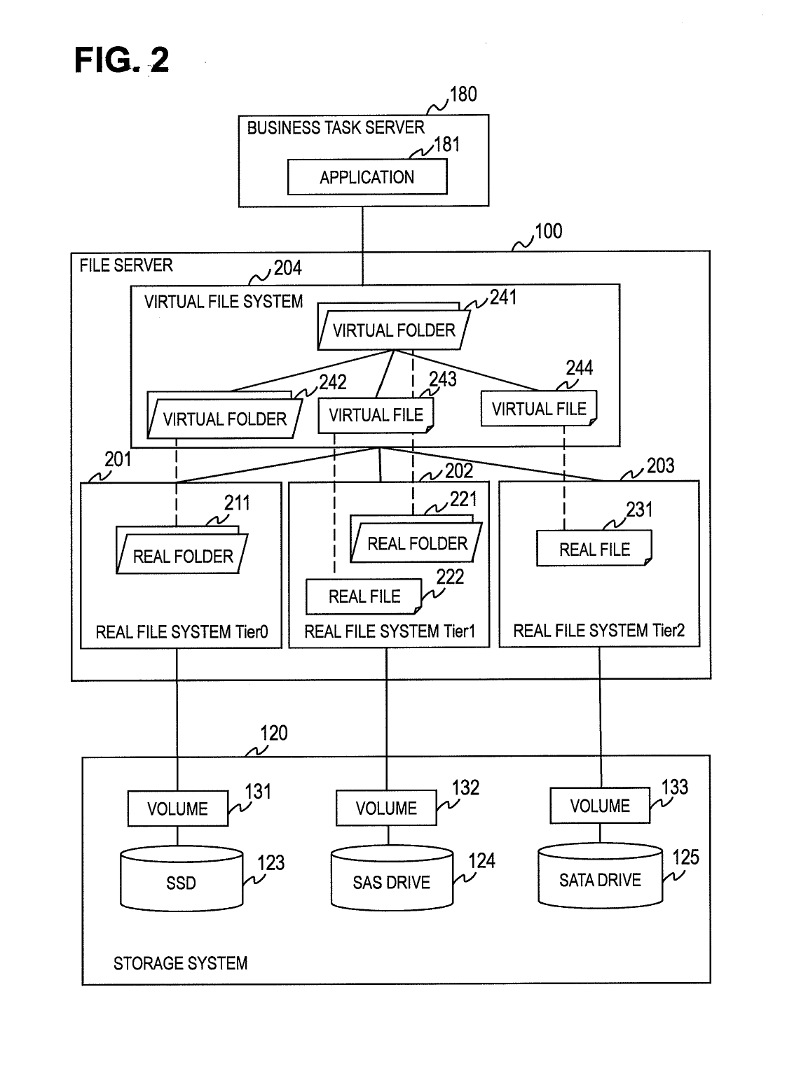

FIG. 2 illustrates a file system configuration example provided by the file server 100 and the storage system 120, and a relationship between volumes and the file systems. The file server 100 includes real file systems 201-203 and a virtual file system 204 for virtualizing the real file systems 201-203.

The virtual file system 204 contains virtual folders (directories) 241 and 242 and virtual files 243 and 244 in the example of FIG. 2. The virtual folder 241 contains the virtual folder 242 and the virtual files 243 and 244. The real file system 201 contains a real folder 211, a real file system 202 contains a real folder 221 and a real file 222, and a real file system 203 contains a real file 231.

The files and folders managed by the file server 100 are allocated to any of the real file systems 201-203, and the virtual file system 204 manages mapping information thereon, and relationship information between the files and the folders. In the example of FIG. 2, the virtual folders 241 and 242 and the virtual files 243 and 244 are respectively associated with the real folders 221 and 211 and the real files 222 and 231.

The business task application program 181 of the business task server 180 makes access to the virtual file on the virtual file system 204, thereby making access to the real file on the real file systems 201-203.

The real file systems 201-203 are divided into tiers, and are different in access performance. Tiers of the real file systems 201, 202, and 203 are respectively Tier0, Tier1, and Tier2 in the example in FIG. 2. The access performance of the real file system 201 of Tier0 is the highest, and the access performance of the real file system 203 of Tier2 is the lowest. The access performance of the real file system 202 of Tier1 is between those of the other real file systems 201 and 203.

The storage system 120 implements three types of storage drive different in access performance as illustrated in FIG. 2. Specifically, the storage system 120 includes an SSD group 123, an SAS drive group 124, and an SATA drive group 125.

The storage controller 121 builds a plurality of volumes including real storage volumes provided by the drive groups 123-125. In this configuration example, the controller 121 builds volumes of three difference access performances depending on the types of the drive. Specifically, the SSD group 123 provides a volume group of Tier0, the SAS HDD group 124 provides a volume group of Tier1, and the SATA HDD group 125 provides a volume group of Tier2. In FIG. 2, volumes 131, 132, and 133 are respectively volumes of Tier0, Tier1, and Tier2.

The access performance is represented by an index such as a response time or a throughput. Drives of the same type are the same in access performance in this configuration example. Typically, redundant arrays of independent disks (RAIDs) including a plurality of drives provide a plurality of volumes (resources).

The volume 131 of Tier0 is assigned to the real file system 201 of Tier0. The volume 132 of Tier1 is assigned to the real file system 202 of Tier1. The volume 133 of Tier2 is assigned to the real file system 203 of Tier2. One or more volumes are assigned to the real file system. A virtual volume to which a partial volume is assigned any time from a pool may be assigned to the real file system.

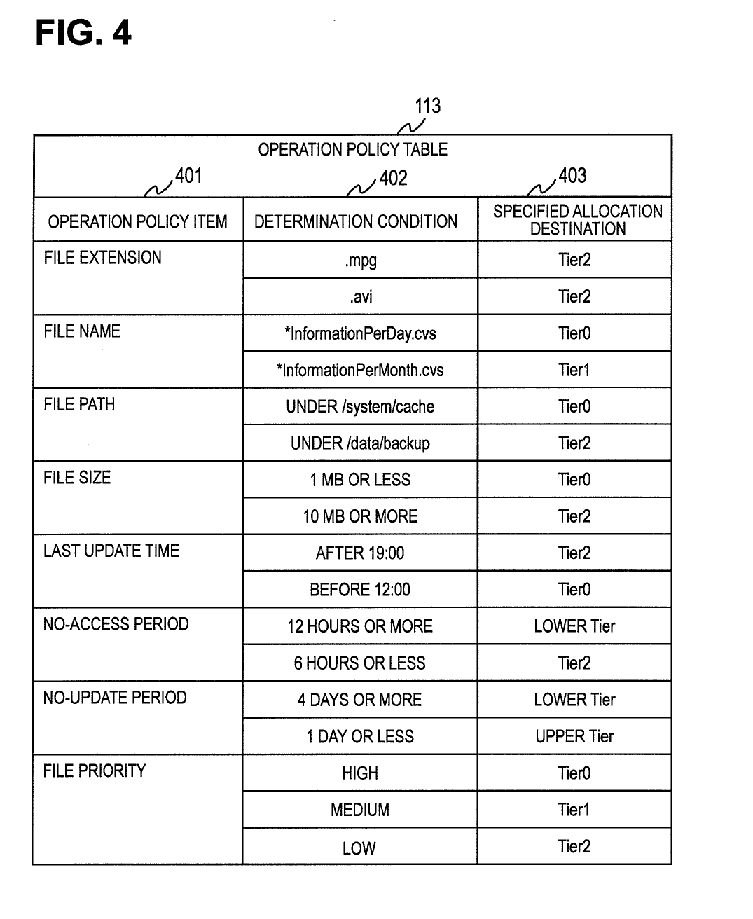

The file system management program 107 of the file server 100 changes and manages the file allocation by migrating real files and real folders on each of the real file systems, and changing information managed by the virtual file system 204. The file system management program 107 determines an allocation destination of a file based on information specified by a user such as an operation policy to be described referring to FIG. 4.

The file system management program 107 can also determine an allocation destination of a folder containing a plurality of files and can migrate the folder in addition to determination of the allocation destination of each file, and migration of each file. For the control of the folder, the file system management program 107 refers to the usage state of all files in a folder, and determines an allocation destination of the folder based on a tendency of the files in the folder

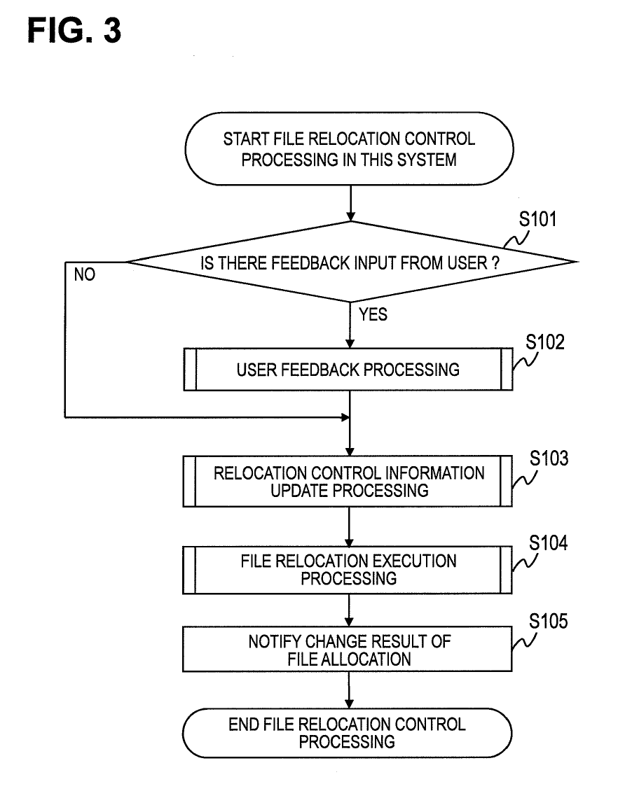

FIG. 3 illustrates a flow of file relocation control processing in the computer system. This flow is executed based on an instruction for the file relocation in a periodical timing such as once a day or by a user. In Step S101, the feedback processing program 109 of the file server 100 checks whether or not there is a feedback input from a user.

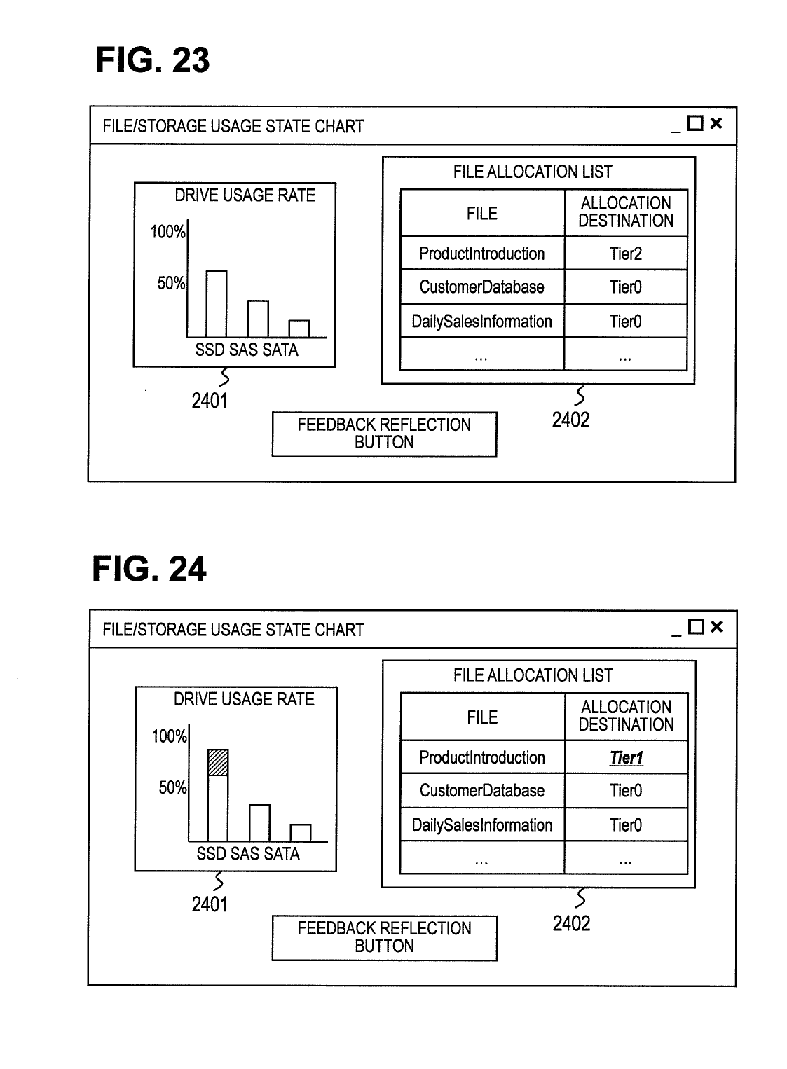

When there is a feedback input (YES in S101), the feedback processing program 109 executes user feedback processing, and updates parameters used by the system (S102). A description is later given of the user feedback processing mainly referring to FIGS. 23 to 28B. When there is not a feedback input (NO in S101), the computer system skips Step S102, and proceeds to Step S103.

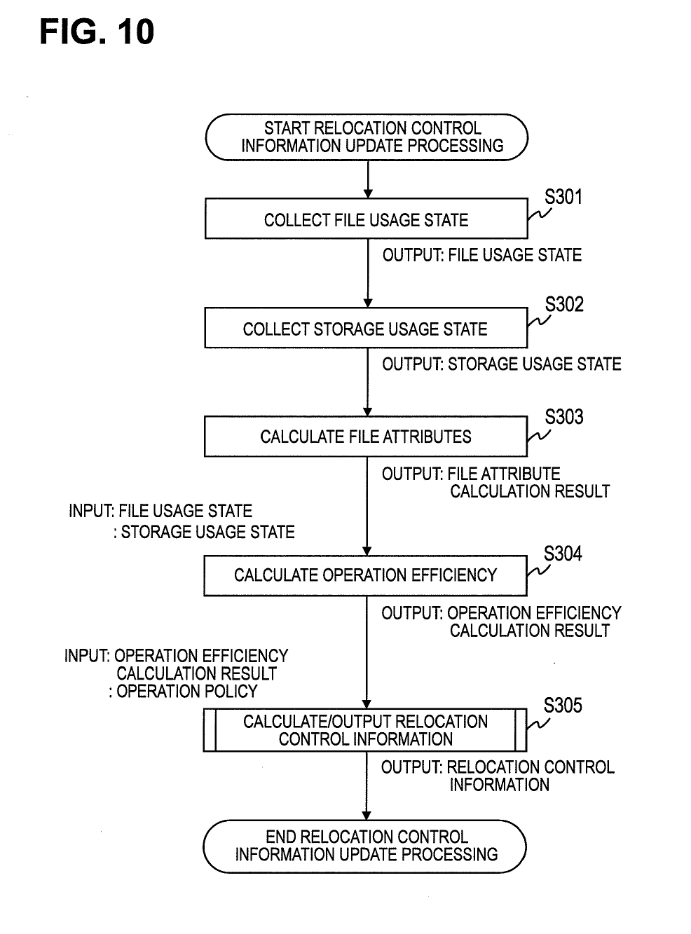

In Step S103, the file relocation control program 108 of the file server 100 updates the relocation control information for controlling the file allocation, and stores the relocation control information in the relocation control table 112. A description is later given of the update processing for the relocation control information mainly referring to FIGS. 10 to 17.

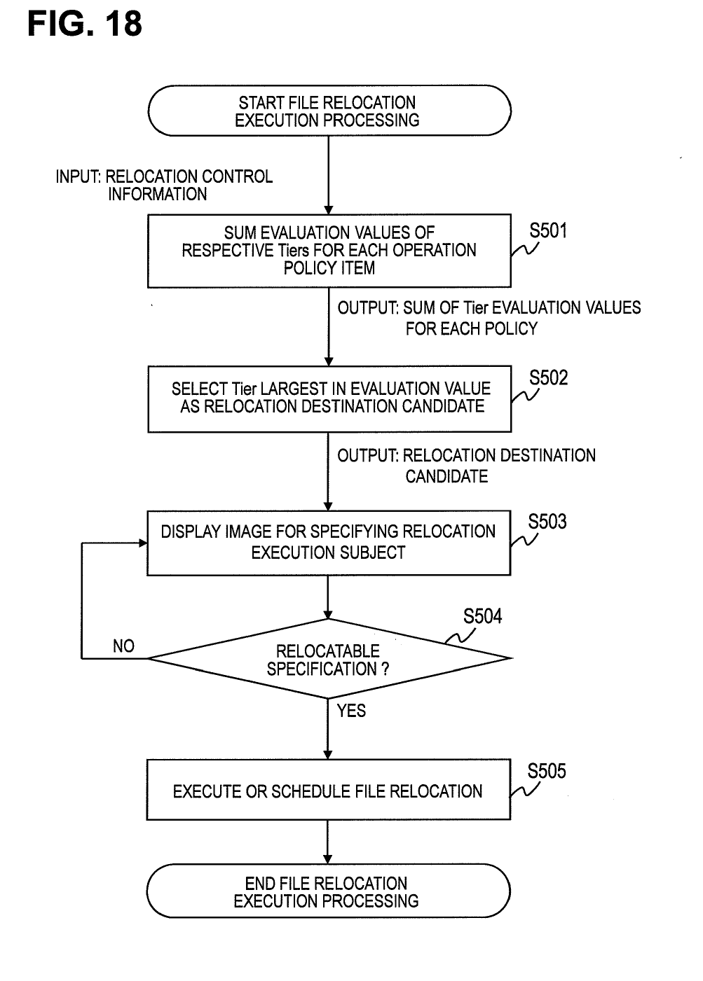

In Step S104, the file system management program 107 of the file server 100 then executes file relocation execution processing, and reflects a result of the change in the file allocation to the file allocation management table 110. A description is later given of the file relocation execution processing mainly referring to FIGS. 18 to 22C. The file system management program 107 notifies the management terminal 160 of the result of the change in the file allocation (S105), and this flow ends.

FIG. 4 illustrates a configuration example of the operation policy table 113 of the file server 100. The operation policy table 113 stores an operation policy configured in advance for the system, or specified by the administrator (user). The operation policy in the operation policy table 113 is information referred to for determining relocation destination candidates of a file.

In the configuration example of FIG. 4, the operation policy table 113 includes an operation policy item column 401, a determination condition column 402, and a specified allocation destination column 403. The information in the operation policy table 113 is typically configured in advance by the administrator. The operation policy table 113 defines an allocation destination (tier) specified for a value of each field (item) in the determination condition column 402 relating to characteristics of files. The file relocation control program 108 uses the information in the operation policy table 113, thereby determining recommended relocation destination candidates based on the characteristics of files.

The operation policy item column 401 represents items of information on a file (characteristic of a file) referred to when the file allocation destination is determined. The operation policy item column 401 includes items (such as file extension and file name) relating to file attributes and items (such as last update time and no-access period) successively changing depending on the usage state of the file server 100.

The determination condition column 402 defines a determination condition for each of the operation policy items. The file relocation control program 108 determines whether or not a value of each of the items defined in the operation policy item column 401 coincides with each of the values in the determination condition column 402 in the file information (file characteristics).

The specified allocation destination column 403 defines a specified allocation destination (tier) corresponding to the each value in the determination condition column 402. “LOWER Tier” and “UPPER Tier” respectively mean a tier lower by one tier than the current tier and a tier upper by one tier than the current tier. If the current tier is the uppermost tier, the upper tier thereof the current tier. If the current tier is the lowermost tier, the lower tier thereof is the current tier.

If characteristics of a file coincide with values of a plurality of fields in the determination condition column 402, a plurality of specified allocation destinations corresponding to the plurality of policy items are assigned to the file. As an example, the file relocation control program 108 determines a tier largest in number of specifications as the specified allocation destination of the file based on the policy table 113. If the numbers of the specifications of a plurality of tiers are the same (two specifications for Tier2 and two specifications for Tier0 are assigned, for example), the file relocation control program 108 determines the intermediate tier Tier1 or the current tier as the policy specified allocation destination.

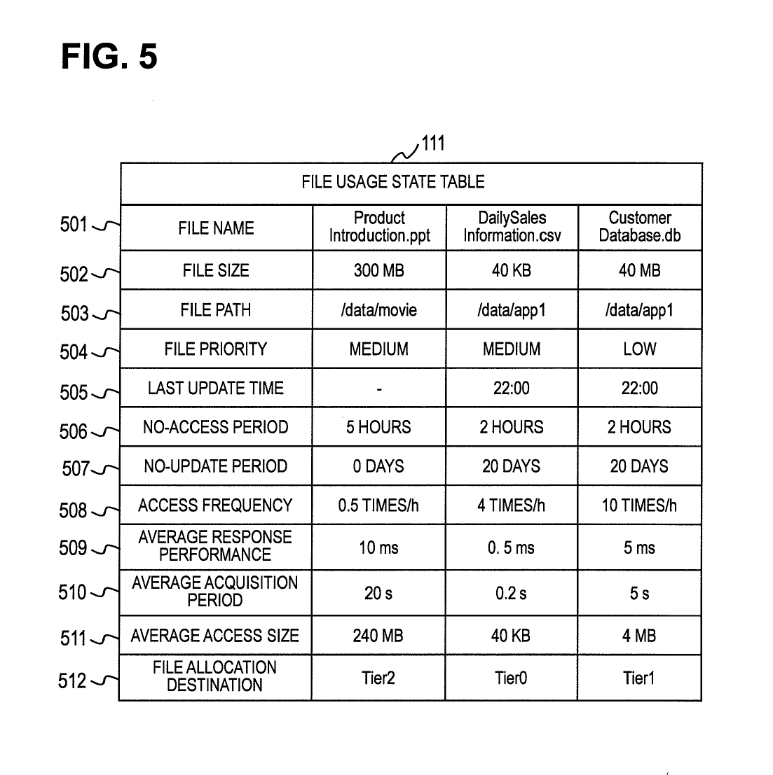

FIG. 5 illustrates a configuration example of the file usage state table 111 of the file server 100. The file usage state table 111 stores information collected by the file usage state collection program 106. Each entry is identified by a value of a field 501 of a file name.

The file usage state table 111 contains attribute information and usage state information on a file. The attribute information is information characterizing file attributes, and fields of the information contain the field 501 of an extension of a file (contained in a file name), a field 502 of a size of the file, a field 503 of a file path, a field 504 of a priority of the file, and a field 512 of a current allocation destination (tier). Values of those fields are updated based on a change in the file attribute by the file usage state collection program 106.

Other fields 505-511 are fields for file usage state information. The usage state collection program 106 acquires information such as an access period and a last update time of a file based on an access history to the file, calculates a no-access period, a no-update period, an access frequency, an average response performance, an average acquisition period, an average access size, and the like, and updates the values in the fields 505-511.

An acquisition period is a period starting from a reception of a read command by the file server 100 to completion of transmission of read data to the business task server 180. The average acquisition period thereof is an average of the acquisition periods of a predetermined number of the read commands, for example.

A response performance is a period starting from the reception of the read command by the file server 100 to start of the transmission of read data to the business task server 180. The average response performance thereof is an average of the response performances of a predetermined number of the read commands, for example.

An access size is a size of data read out by one access. If one access is directed to continuous addresses, a plurality of commands may be executed. The average access size refers to an average of the accesses of a predetermined number of times.

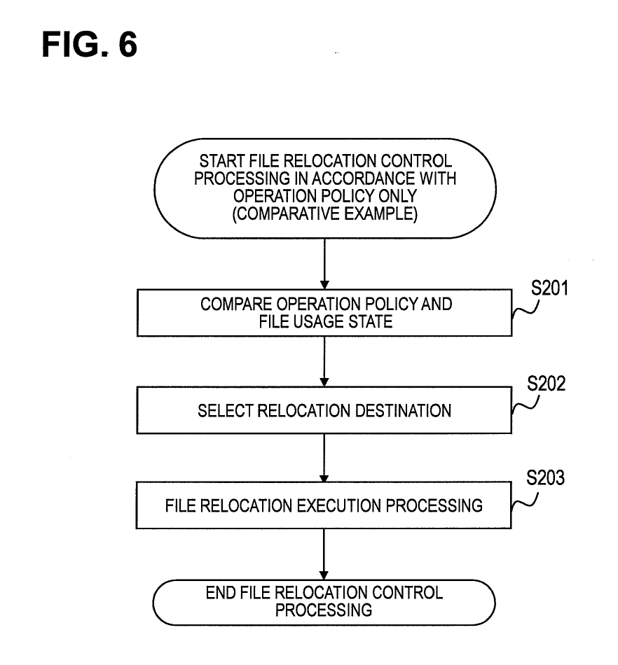

FIG. 6 illustrates a flow of file relocation processing of a comparative example of this embodiment. According to this comparative example, a relocation destination (tier) of each file is determined only in accordance with an operation policy in the operation policy table 113 illustrated in FIG. 4. This comparative example first compares the operation policy in the operation policy table 113 and the information in the file usage state table 111 with each other (S201).

The comparative example determines a relocation destination of a file in accordance with a comparison result in Step S201 (S202). Specifically, this comparative example acquires information on each file from the file usage state table 111, refers to the operation policy table 113, and determines whether or not the information satisfies the determination conditions of each operation policy item. Further, this comparative example selects, from the operation policy table 113, one or more specified allocation destinations (specified tiers Tier0, Tier1, and Tier2) corresponding to one or more determination conditions satisfied by the file information.

The comparative example determines a tier which has the largest number of specifications as the relocation destination out of the one or more acquired specified allocation destinations. If the numbers of the specifications of a plurality of tiers are the same, the current tier or the intermediate tier Tier1 is selected as the relocation destination of the file, for example. The comparative example relocates each file to the relocation destination determined in Step S202 (S203).

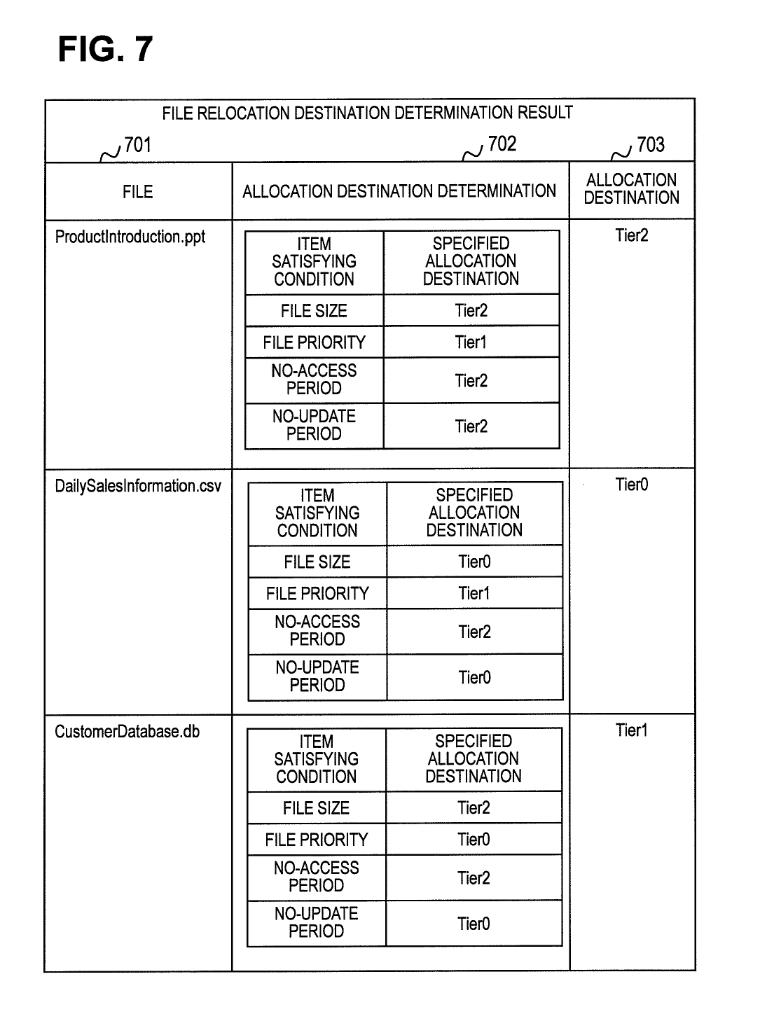

FIG. 7 illustrates a result of the determination processing for the file relocation destination of FIG. 6. In FIG. 7, a file column 701 stores file names registered in the file usage state table 111.

An allocation destination determination column 702 represents items satisfying the determination conditions of the operation policy in the file information, and a specified allocation destination of each of the items. A allocation destination column 703 represents tiers largest in number of specifications out of the specified allocation destinations in the allocation destination determination column 702. In an entry of “CustomerDatabase.db”, both the numbers of specifications for Tier2 and Tier0 are 2. In this example, the current tier of “CustomerDatabase.db”, that is, Tier 1 is selected as the relocation destination.

For example, the file size of “ProductIntroduction.ppt” is “300 MB”, and the specified allocation destination thereof is Tier2. The file priority thereof is “MEDIUM”, and the specified allocation destination thereof is Tier1. The no-access period thereof is five hours, and the specified allocation destination thereof is Tier2. The no-update period thereof is 0 days, and the specified allocation destination thereof is Tier2. Tier2 has the largest number of specifications, and the value of the field in the allocation destination column 703 of “ProductIntroduction.ppt” is thus Tier2.

The comparative example determines a relocation destination of a file by referring to a fixed operation policy. A configuration example of this embodiment refers to a usage state of a file and the usage state of the storage system 120, thereby evaluating relocation destination tier candidates of the file. As a result, optimization control for the file allocation considering both the file system and the storage system is enabled, and the operation efficiency of the storage system 120 can increase for the virtual file system 204.

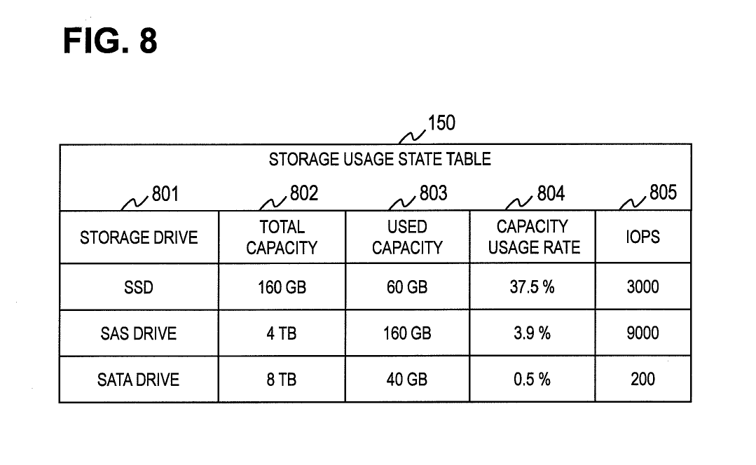

FIG. 8 illustrates a configuration example of the storage usage state table 150. The storage usage state table 150 stores capacities, usage rates, IOPSs, and the like of the physical storage drives and the virtual storage drives managed by the storage system 120. The storage usage state collection program 147 acquires the usage state information on the storage system 120 from the storage controller 121, and stores the information in the storage usage state table 150.

The storage usage state table 150 includes a storage drive column 801, a total capacity column 802, a used capacity column 803, a capacity usage rate column 804, and an input output per second (IOPS) column 805. The storage drive column 801 stores storage drives of each type, and an SSD, which is a high performance drive, an SAS drive, which is a medium performance drive, and an SATA drive, which is a low performance drive, are registered in this example.

“TOTAL CAPACITY” is a sum of capacities of all the drives of each type. “USED CAPACITY” represents a capacity currently used, “CAPACITY USAGE RATE” is a rate of “USED CAPACITY” with respect to “TOTAL CAPACITY”. “IOPS” represents an access frequency, specifically, an average of access numbers per second in a predetermined period.

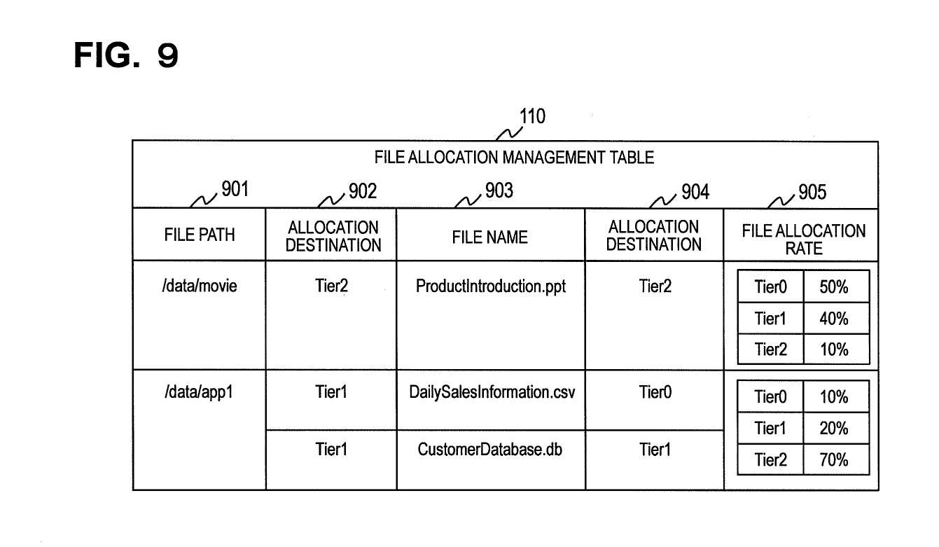

FIG. 9 illustrates a configuration example of the file allocation management table 110 of the file server 100. The file allocation management table 110 stores information used by the virtual file system to manage allocation destinations of real files and real folders. Specifically, the file allocation management table 110 includes a file path column 901, an allocation destination column 902 for a folder (file path), a file name column 903, an allocation destination column 904 for a file, and a file allocation rate column 905.

The file path column 901 stores folder names of the virtual file system. The allocation destination column 902 stores information representing tiers on which folders (represented by the file paths) are allocated. The file name column 903 stores file names of files stored in the folders. The allocation destination column 904 stores information on tiers on which the files are allocated. The file allocation rate column 905 represents rates of the numbers of the files stored on the tiers in each folder.

FIG. 10 illustrates a flow of update processing for the file relocation control table 112. This processing corresponds to Step S103 in the flowchart of FIG. 3. The file usage state collection program 106 stores information on the usage states of the files in the file usage state table 111 (S301). The storage usage state collection program 147 acquires the usage state information on the storage system 120 from the storage controller 121, and stores the information in the storage usage state table 150 (S302).

The file relocation control program 108 acquires information from the file usage state table 111, and calculates file attributes required for the relocation control based on the characteristics of the files (S303). The method of calculating the file attributes is described later.

The file relocation control program 108 further refers to the file usage state table 111 and the storage usage state table 150, thereby calculating the operation efficiency as an index for evaluating the allocations of the files and the usage efficiency of the storage system 120 in combination (S304). The operation efficiency is an index for evaluating whether the storage system 120 is efficiently operated, and whether the files are allocated in accordance with the policy, and the calculation method thereof is described later.

The file relocation control program 108 calculates the relocation control information on the files using the operation efficiency calculated in Step S304 and the operation policy in the operation policy table 113, and stores the calculated relocation control information in the relocation control table 112 (S305).

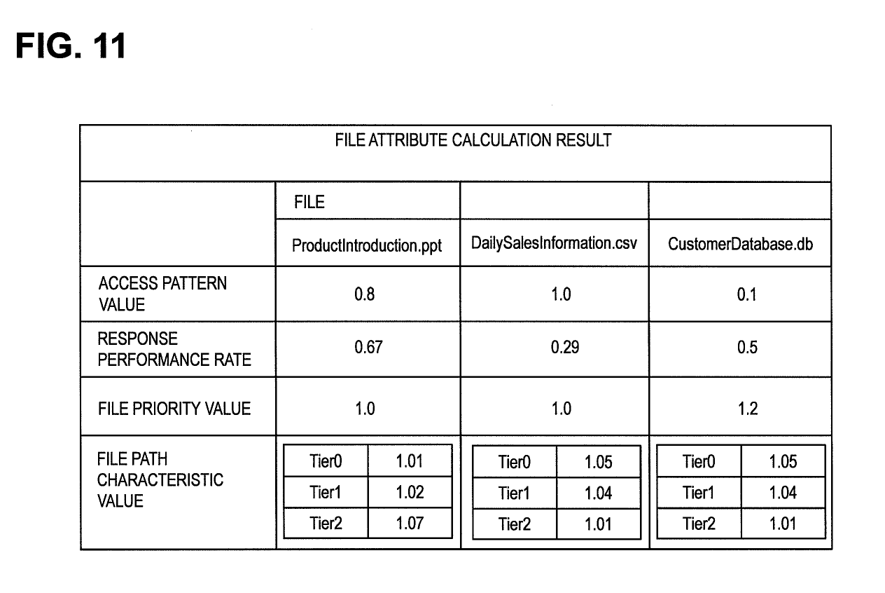

A detailed description is now given of the steps executed in the flow in FIG. 10. FIG. 11 illustrates an example of the calculation result of the file attributes output in Step S303. The file relocation control program 108 calculates the attributes of the files, and outputs a calculation result in a form of numerals. The output result is stored in the memory 102.

As illustrated in FIG. 11, the file relocation control program 108 calculates an access pattern value Afile, an response performance rate Rfile, a file priority value Pfile, and a file path attribute value Ffile[Tier[i]] as the file attributes of each of the files. As these values increase, a corresponding file is preferably allocated on a layer of a higher performance. The file path attribute value Ffile[Tier[i]] implies that it is a value for Tier[i] (i is 0, 1, or 2). Calculation equations (functions) for the values are described below:

Afile=average access size/file size

Rfile=average acquisition period/(average response performance+average acquisition period)

Pfile=high:0.8,medium:1.0,and low:1.2

Ffile[Tier[i]]=1+file allocation rate [Tier[i]]×0.1

The access pattern value Afile is a ratio of data size accessed at once with respect to the file size. The file relocation control program 108 can acquire the values of the average access size and the file size of the file from the file usage state table 111.

The response performance rate Rfile represents an average response performance value with respect to a file access. The file relocation control program 108 can acquire the values of the average response performance and the average acquisition period of the file from the file usage state table 111. These values decrease as the average acquisition period increases with respect to the average response performance. If the average acquisition period increases, influence of the average response performance on the file access decreases, and the response performance required for the file decreases.

A numerical value of the file priority value Pfile is a value configured in advance. The file relocation control program 108 can acquire the priority value (high, medium, or low) of the file from the file usage state table 111. The file path attribute value Ffile[Tier[i]] represents a characteristic of a file path. The file relocation control program 108 can acquire the file allocation rate of each of the tiers of the each file path from the file usage state table 110. The file path attribute value is used to evaluate a relocation destination by considering that a file group allocated on the same file path (folder) has a common characteristic in a required performance.

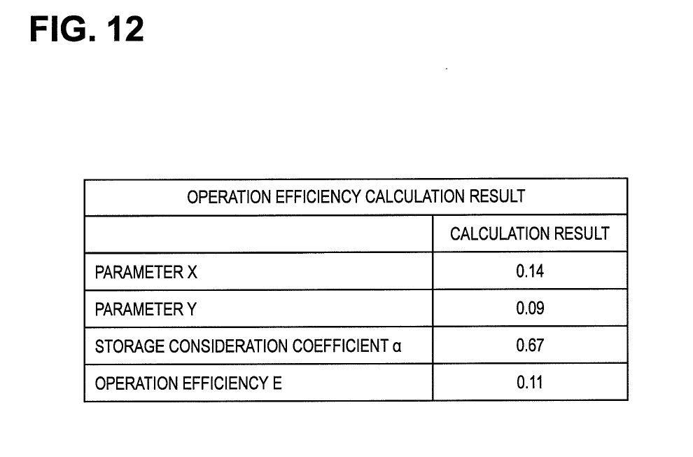

FIG. 12 illustrates an example of the calculation result of the operation efficiency E calculated in Step S304 of FIG. 10. The operation efficiency is a value representing the efficiency of the storage operation, and can be calculated based on a function of an evaluation index relating to the files and an evaluation index relating to the storage system 120. Parameters X and Y and a storage consideration coefficient α are contained in a function of the operation efficiency E. The operation efficiency E is represented by the following function, for example. The following function is an example, and the operation efficiency may be calculated based on another function.

E(X,Y)=(1−α)X+αY

X is an index relating to the access performance of the files. Y is an index relating to the operation efficiency of the storage system 120 itself, and is an index relating to the usage efficiency of the SSD in this example. α is a storage consideration coefficient, and is a coefficient for the storage system performance. The SSD is a drive highest in performance in this system. If a drive of a type different from the SSD has the highest performance, the drive of this type will be selected.

The index X relating to the performance of the files is represented by the following function, for example.

X=Σ(performance evaluation value Vfile×frequency file)/Σ(frequency file)

The performance evaluation value Vfile is represented by the following function.

Vfile=Rfile×Afile×Pfile

As described above, Rfile, Afile, and Pfile are respectively the response performance rate, the access pattern value, and the priority value of the file. Σ means summation of values of all the files. “Frequency file” means an access frequency to a file, and can be acquired from the file usage state table 111.

The index relating to the usage efficiency of the SSD (index relating to the efficiency of the storage operation) Y is represented by the following function including a capacity usage rate U of the SSD, and an IO rate I of the SSD, for example. As Y increases, the usage efficiency of the storage system 120 itself increases.

Y=U×I

The IO rate I of the SSD is represented by the following function.

I=(IOPS of SSD)/(all IOPSs in storage system)

The capacity usage rate U of the SSD and the IOPSs of the drive types are stored in the storage usage state table 150, and the file relocation control program 108 acquires these values from the storage management server 140.

The storage consideration coefficient α is information stored in the parameter table 115, and represents a rate of the evaluation for the usage efficiency of the storage system 120. When the usage efficiency of the storage system 120 is low, it is possible to increase the evaluation value for a drive higher in performance by increasing the storage consideration coefficient α. The storage consideration coefficient α has an initial value determined by the system, but the administrator may change the storage consideration coefficient α.

As described above, the operation efficiency E is an index for evaluating the usage efficiency of the storage system 120 with respect to the virtual file system 204, and is determined by considering both the usage state of the files and the storage system 120. A higher value of the operation efficiency implies that the storage system 120 is more efficiently operated in response to a request from the virtual file system 204.

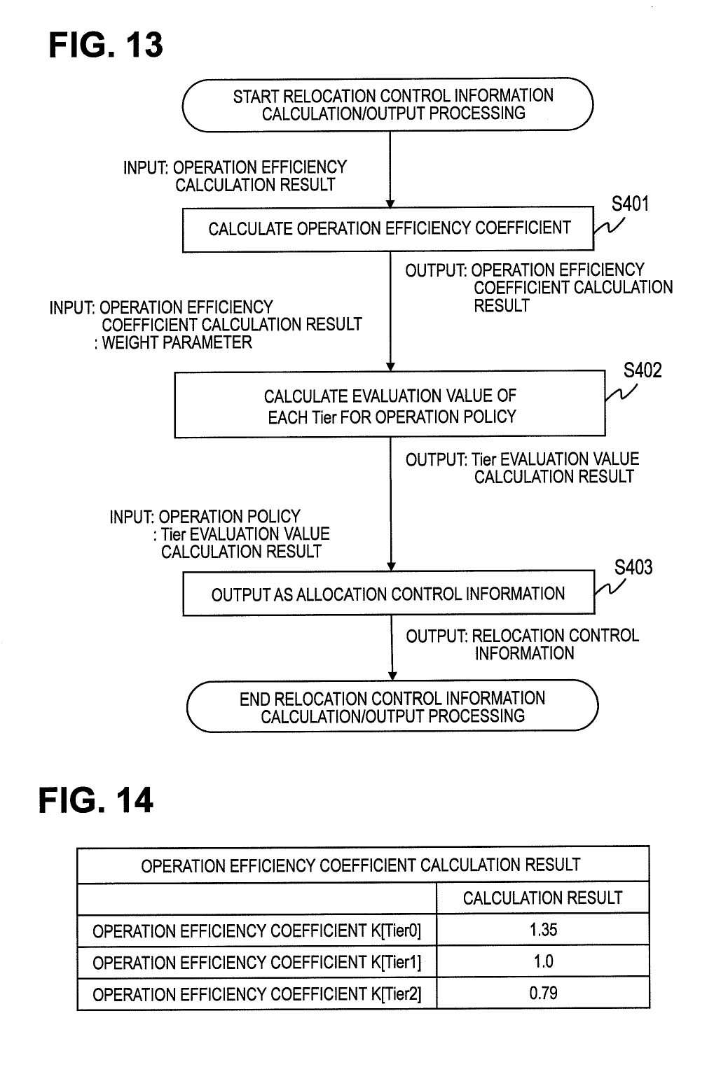

FIG. 13 illustrates a flow of the step of calculating/outputting the relocation control information (S305) of FIG. 10. The file relocation control program 108 calculates parameters for outputting the relocation control information from the result of the operation efficiency calculation in Step S304 (FIG. 12) (S401, S402). Specifically, the file relocation control program 108 calculates operation efficiency coefficients K representing weights of the allocation destination Tiers as the parameters for the calculation (S401).

Further, the file relocation control program 108 calculates evaluation values for allocation destination Tiers corresponding to determination conditions of the operation policy table 113 (S402). This calculation uses weight parameters stored in the parameter table 115 as an input. The file relocation control program 108 generates the relocation control information from the calculated Tier evaluation values and the operation policy table 113, and stores (outputs) the relocation control information in (to) the relocation control table 112 (S403).

A specific description is now given of a calculation method of the operation efficiency coefficients K in Step S401. The operation coefficient K[[Tier[i]] of each of the tier [Tier[i]] is represented by the following function containing the operation efficiency E.

K[Tier0]=1.5/(1+E)

K[Tier1]=1

K[Tier2]=1.5/(2−E)

FIG. 14 illustrates an example of the calculation result of the operation efficiency coefficients based on the above-mentioned functions. The value of the operation coefficient E is 0.11 in this example, and coincides with the value of the operation efficiency calculation result illustrated in FIG. 12. The calculation result example of the operation efficiency coefficients K is output to the calculation result storage area 114 in the memory 102. The operation efficiency coefficient K weights the evaluation of the allocation destination Tier based on the magnitude of the value of the operation efficiency E.

As the operation efficiency E increases, the operation efficiency coefficient K decreases for the high performance tiers, and the operation efficiency coefficient K increases for the low performance tiers. In other words, the value of the function K[Tier0] for Tier0 decreases as the operation efficiency E increases, and the value of the function K[Tier2] for Tier2 increases as the operation efficiency E increases.

A specific description is now given of an example of a method of calculating the evaluation values of the allocation destination tiers for the operation policy table 113 in Step S402. In Step S402, the evaluation values of the allocation destination tiers are calculated for the specified allocation destinations in the operation policy table 113 (FIG. 4). The file relocation control program 108 uses the weight parameters for calculating the evaluation values of the allocation destination tiers for the operation policy table 113.

FIG. 5 illustrates an example of the weight parameter table 1500. The weight parameter table 1500 is contained in the parameter table 115. The weight parameter table 1500 defines the weight parameters of the tiers Tier0, Tier1, and Tier2 for the specified allocation destinations in the operation policy table 113. For example, the weight parameters W of Tier0 for specified allocation destinations Tier0, Tier1, Tier2, upper tiers, and lower tiers are 10, 7, 2, 10, and 6, respectively.

The weight parameters W of Tier1 for specified allocation destinations Tier0, Tier1, Tier2, upper tiers, and lower tiers are 6, 10, 6, 8, and 8, respectively. The weight parameter table 1500 contains initial values determined by the system. The weight parameters are updated by a feedback from the user.

The file relocation control program 108 calculates the evaluation values of the tiers for each of the specified allocation destinations in the operation policy table 113 by using the values in the weight parameter table 1500. FIG. 16 illustrates a calculation result of the evaluation values of the tiers. In FIG. 16, one row is an entry for storing evaluation values of the one tier for each of the specified allocation destinations in the operation policy. For example, the evaluation value of Tier0 for the specified allocation destination Tier1 is 0.4, and the evaluation value for the upper tiers is 0.56.

The evaluation values T[Tier0, Tier[i]] of the tier Tier0 for the specified allocation destinations in the operation policy table 113 are represented by the following functions.

T[Tier0,Tier[i]]=K[Tier0]×W[Tier0,Tier[i]]/ΣW[Tier[i]]

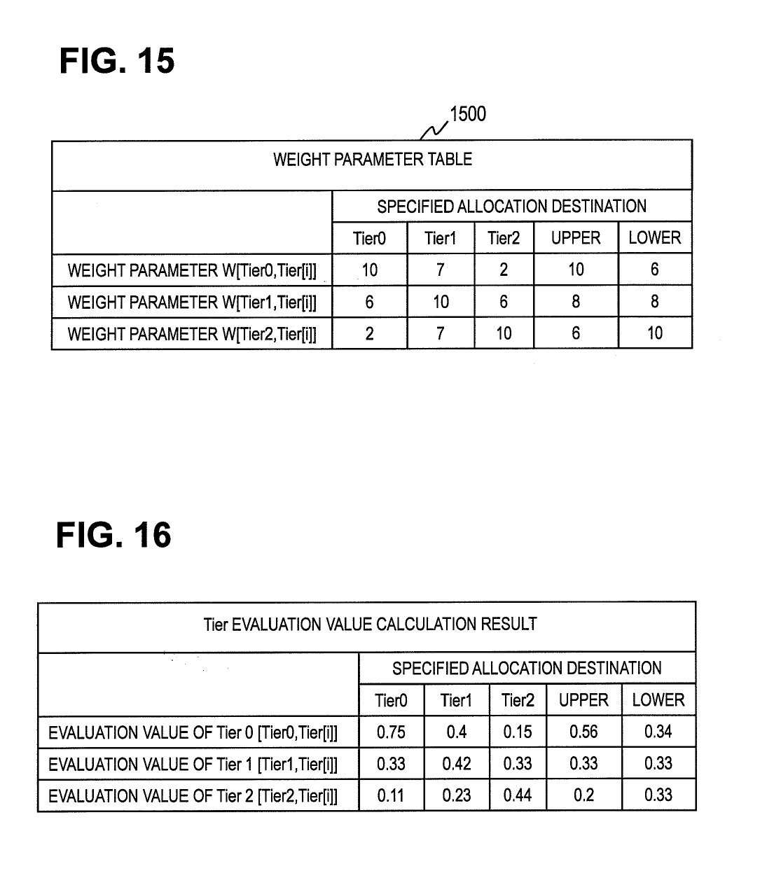

K[Tier0] is an operation efficiency coefficient of Tier0, and is 1.35 in the example illustrated in FIG. 14. W[Tier0, Tier[i]] is a weight parameter of Tier0 for the operation-policy-specified allocation destination Tier[i]. In the example illustrated in FIG. 15, the weight parameter W[Tier0,Tier1] of Tier0 for the specified allocation destination Tier1 in the operation policy table 113 is 7. The specified allocation destinations Tier[i] include the upper tiers and the lower tiers.

ΣW[Tier[i]] is a sum of the weight parameters for the specified allocation destination Tier[i] in accordance with the operation policy table 113, and is a sum in the column of the weight parameter table 1500 illustrated in FIG. 15. For example, in the calculation of the evaluation value T[Tier0,Tier1] of Tier0 for the specified allocation destination Tier1, ΣW[Tier1] is a sum of W[Tier0,Tier1], W[Tier1,Tier1], and W[Tier2,Tier1]. A value thereof is 24 in the example illustrated in FIG. 15.

Evaluation values can be similarly calculated for the other layers other than Tier0. In other words, the evaluation values of the tiers Tier1 and Tier2 are represented by the following functions.

T[Tier1,Tier[i]]=K[Tier1]×W[Tier1,Tier[i]/ΣW[Tier[i]]

T[Tier2,Tier[i]]=K[Tier2]×W[Tier2,Tier[i]]/ΣW[Tier[i]]

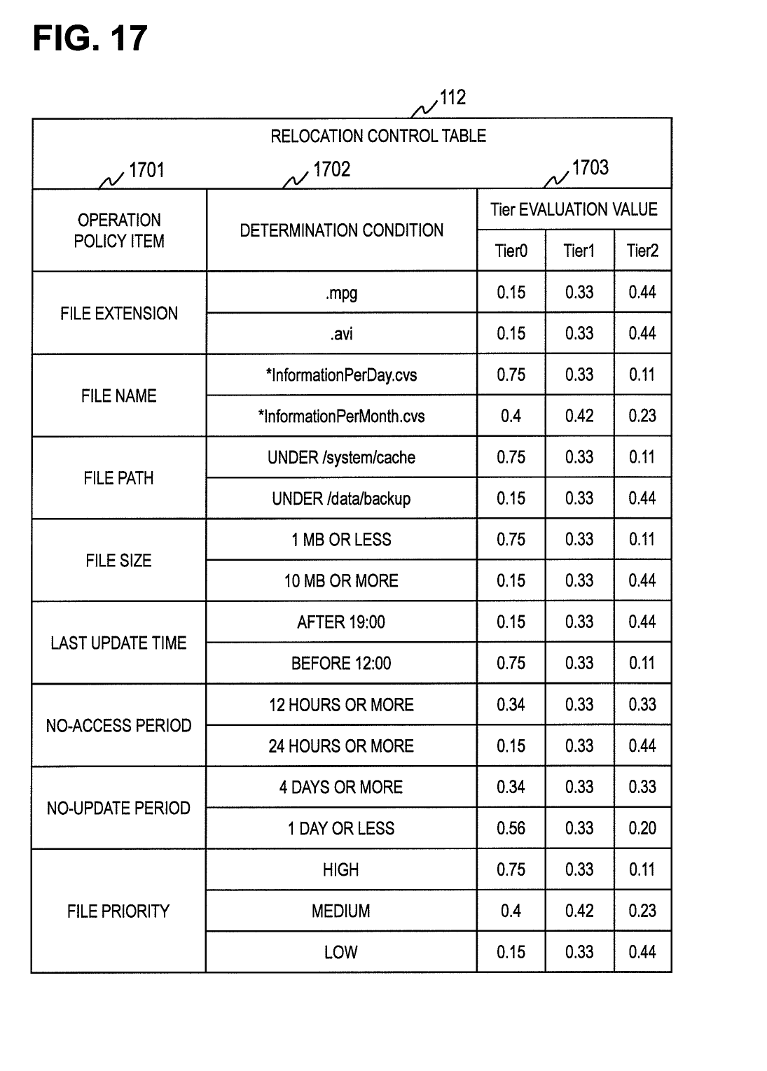

FIG. 17 illustrates an example of the relocation control table 112. The relocation control table 112 stores the output result of the relocation control information, thereby associating the characteristics of a file with the evaluation values of the tiers. The file relocation control program 108 calculates the file relocation control information from the operation policy table 113 and the evaluation values (FIG. 16) of the tiers for the allocation destinations (tiers) specified by the operation policy table 113.

The relocation control table 112 includes an operation policy item column 1701, a determination condition column 1702, and a Tier evaluation value column 1703. Values in the operation policy item column 1701 and the determination condition column 1702 are the same as the values in the operation policy item column 401 and the determination condition column 402 in the operation policy table 113. The operation policy item column 401 defines the items of the file characteristics.

The Tier evaluation value column 1703 stores evaluation values of the allocation destination tiers Tier0, Tier1, and Tier2 for the allocation destinations (tiers) specified by the operation policy table 113. In the Tier evaluation value column 1703, each row stores a value of a corresponding column in the evaluation result of the tiers (FIG. 16). The value of the specified allocation destination in the operation policy table 113 identifies a corresponding column of the Tier evaluation values.

For example, in the operation policy table 113, the specified allocation destination for a file extension “.mpg” is Tier2. Numerical values stored in a column of the specified allocation destination Tier2 in FIG. 16 are evaluation values of the tiers, 0.15 [Tier0], 0.33 [Tier1], and 0.44 [Tier2] for the allocation destination Tier2 specified by the operation policy table 113. The evaluation values of Tier0, Tier 1 and Tier2 for the file extension “.mpg” are thus 0.15, 0.33, and 0.44 in the relocation control table 112 of FIG. 17.

The file relocation control program 108 can calculate the control information to be used to determine a relocation destination of a file from the operation policy table 113 and the calculation result of the evaluation values (Tier evaluation values) of the tiers for the specified allocation destinations in the operation policy table 113 in this way.

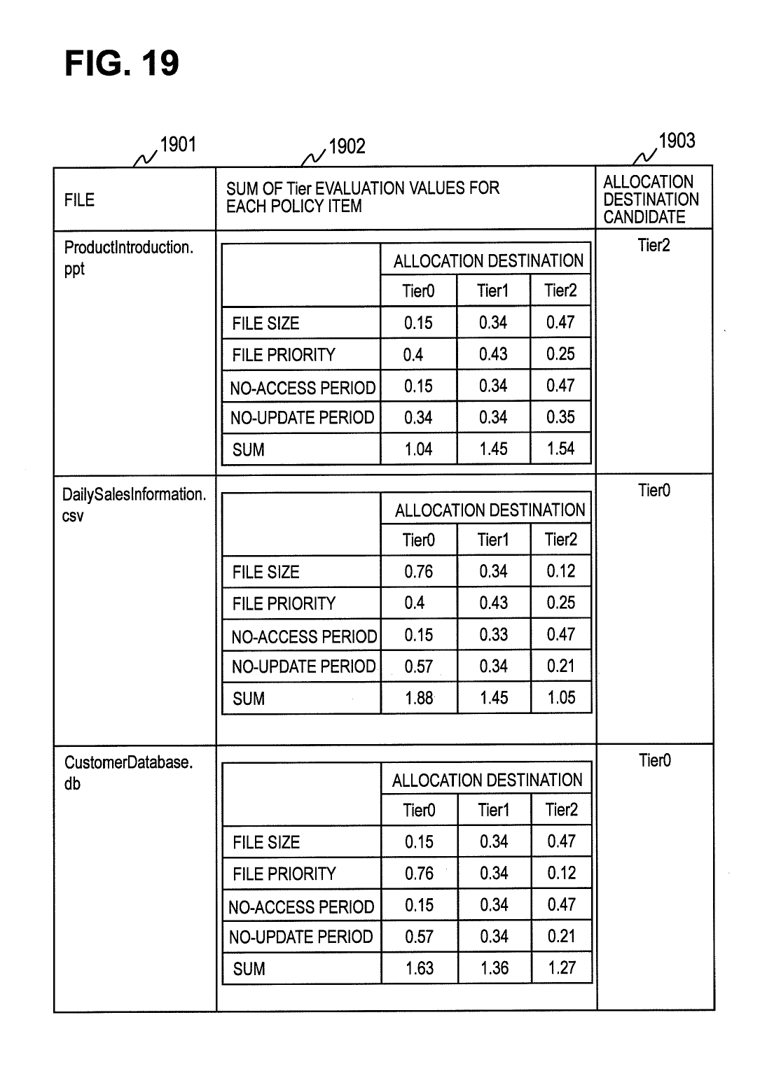

A description is now given of a flow of the file relocation execution processing referring to a flowchart of FIG. 18 and FIG. 19. The flow corresponds to Step S104 in the flowchart of FIG. 3. The file system management program 107 executes the flow illustrated in FIG. 18 referring to the relocation control table 112 and the file usage state table 111. FIG. 19 illustrates a calculation result (intermediate calculation result) in the course of the flow. FIG. 19 includes a file column 1901, a sum of Tier evaluation values for each policy item column 1902, and an allocation destination candidate column 1903, and illustrates entries for the three files.

In Step S501 of FIG. 18, the file system management program 107 sums evaluation values of one or more operation items of each of Tiers. A specific description is now given of Step S501.

The file system management program 107 sequentially selects information on each of the files from the file usage state table 111. The file system management program 107 identifies operation items coincident with the determination conditions in the relocation control table 112, and acquires three Tier evaluation values for the operation items.

The file system management program 107 calculates products of the three acquired Tier evaluation values by the file path attribute values F[Tier[i]]. These three values are the three Tier evaluation values for one operation policy item of the file.

In an example illustrated in FIG. 19, tier evaluation values of the operation policy item “FILE SIZE” of “ProductIntroduction.ppt” file are 0.15 [Tier0], 0.34 [Tier1], and 0.47 [Tier2]. As illustrated in FIG. 5, the file size of “ProductIntroduction.ppt” is 300 MB, and satisfies a determination condition for the file size “10 MB OR MORE” in the relocation control table 112 illustrated in FIG. 17.

Tier evaluation values of the “FILE SIZE” item of “ProductIntroduction.ppt” file in the relocation control table 112 are thus 0.15 [Tier0], 0.33 [Tier1], and 0.44 [Tier2].

File path attribute values Ffile[Tier[i]] of “ProductIntroduction.ppt” are 1.01 [Tier0], 1.02 [Tier1], and 1.07 [Tier2] as illustrated in FIG. 11. Values obtained by multiplying, respectively, the Tier evaluation values in the relocation control table 112 by corresponding file path attribute values are the Tier evaluation values in “ProductIntroduction.ppt” illustrated in FIG. 19.

The file system management program 107 further calculates the sums of the Tier evaluation values of the Tiers [i] for each of the files. “SUM” represents these values in FIG. 19. As illustrated in FIG. 19, the entry of each of the files includes the evaluation values of the plurality of policy items for the Tiers. For example, four evaluation values are associated with Tier0 of “ProductIntroduction.ppt” file. The file system management program 107 calculates the sum of these values.

In Step S502, the file system management program 107 then selects a tier (Tier[i]) highest in the summed evaluation value as a relocation destination candidate of a file. Specifically, the file system management program 107 refers to the sums of the evaluation values for each of the files, and selects Tier[i] largest in the sum as a recommended relocation destination candidate for the file.

In the example illustrated in FIG. 19, the sums of evaluation values of the tiers (Tier[i]) of “ProductIntroduction.ppt” file are 1.04 [Tier0], 1.45 [Tier1], and 1.54 [Tier2]. The file system management program 107 thus selects Tier2 as the allocation destination candidate of “ProductIntroduction.ppt” file. The file system management program 107 selects a tier highest in the sum of the evaluation values as a recommended allocation destination candidate similarly for each of the other files.

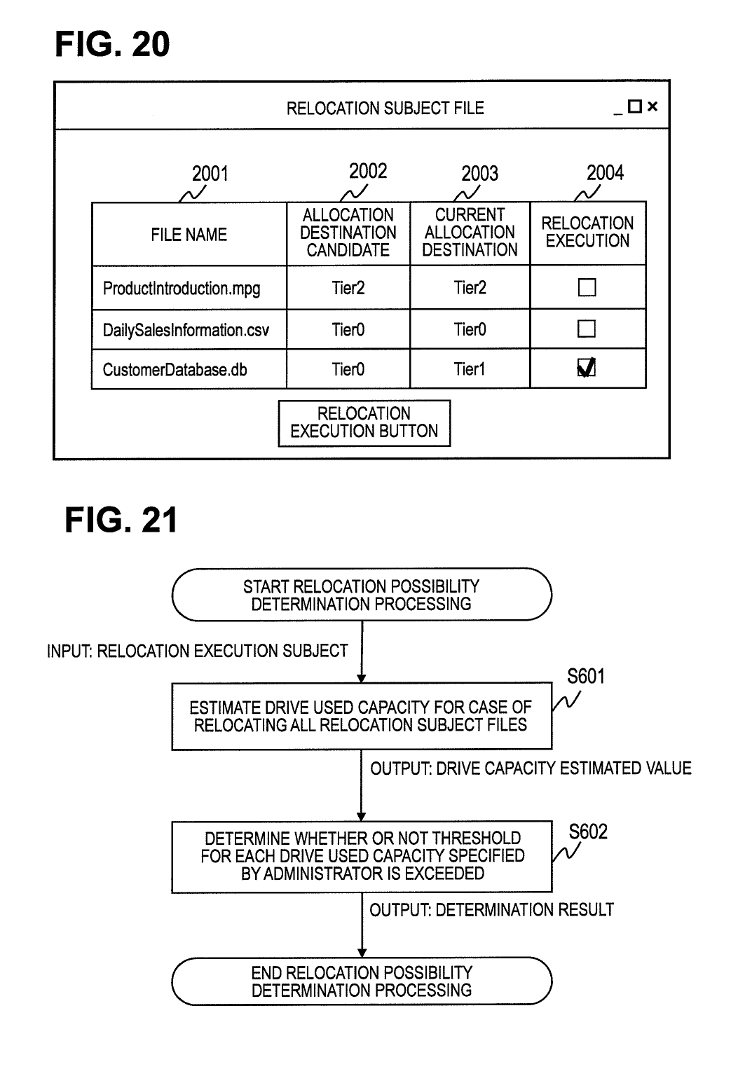

In Step S503, the file system management program 107 displays a relocation subject file selection image. The file system management program 107 transmits data to the management terminal 160, and the management terminal 160 displays an image of the received data. FIG. 20 illustrates an example of the relocation subject file selection image on a display apparatus of the management terminal 160. The relocation subject file selection image includes a column for file name 2001, a column for allocation destination candidate 2002, and a column for current allocation destination 2003. Further, the relocation subject file selection image includes a column 2004 of checkboxes for relocation execution.

The column for allocation destination candidate 2002 represents an allocation destination candidates of the files determined in Step S502. The administrator selects and specifies files to be relocated in the column 2004 of checkboxes by using an input device of the management terminal 160. When the administrator depresses a relocation execution button, the management terminal 160 transmits information containing identification information of the selected files to the file server 100. When the file system management program 107 receives the identification information on the selected files, the file system management program 107 executes Step S504 in the flowchart of FIG. 18.

In Step S504, the file system management program 107 determines whether all the selected files can be relocated to the relocation destination candidates in the column for relocation destination candidates 2002. A description is later given of the determination method referring to FIG. 21.

When the selected files can be relocated to the allocation destination candidates (YES in S504), the file system management program 107 executes or schedules the relocation of the files (S505). When any of the selected files cannot be relocated to the allocation destination candidates (NO in S504), the file system management program 107 returns to Step S503, and displays the fact that the files selected last time cannot be relocated along with the relocation subject file selection image by the management terminal 160.

The image example of FIG. 20 displays only tiers of the allocation destination candidate column 1903 illustrated in FIG. 19, but the evaluation values may be displayed along with the tiers. Moreover, the management terminal 160 (file system management program 107) may display other tiers for selection by the administrator along with the most recommended relocation destination candidates. In this case, a degree of recommendation (such as the Tier evaluation value in this example) of each of the tiers is displayed along with the tier.

A flowchart of FIG. 21 illustrates details of the determination in Step S504 in the flowchart of FIG. 18. The file system management program 107 estimates used capacities (such as capacity usage rate) of the drive types when all the files selected as the relocation subjects are relocated (S601).

Specifically, the file system management program 107 refers to the file usage state table 111, thereby identifying file sizes of the files to be relocated, and further refers to the storage usage state table 150 representing the current storage usage state, thereby estimating the used capacity of the drive types after the file relocation.

Further, the file system management program 107 compares the estimated used capacities of the drive types with thresholds configured in advance by the administrator, thereby determining whether these values do not respectively exceed the thresholds (S602), and determines that the relocation is possible when these values do not respectively exceed the thresholds.

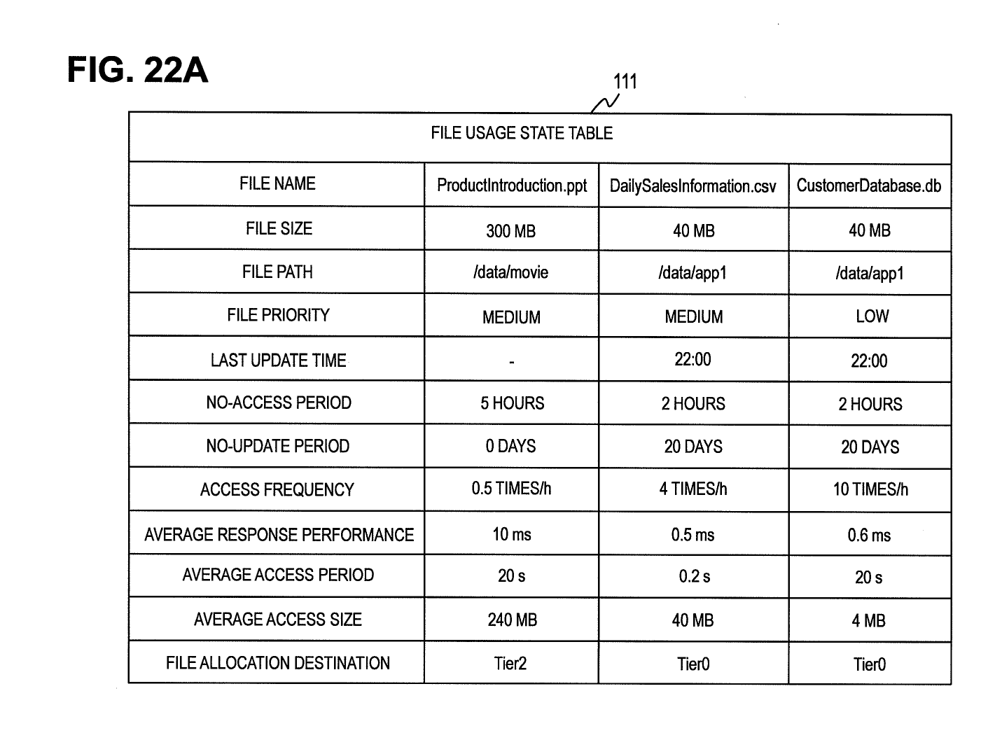

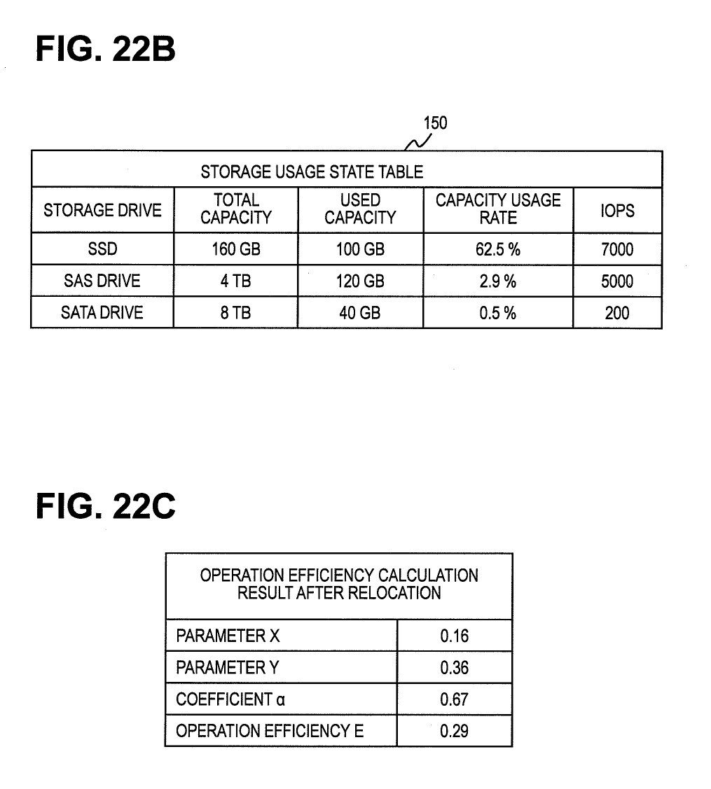

FIG. 22A and FIG. 22B respectively illustrate an example of the file usage state table 111 and an example of the storage usage state table 150 after the file relocation. As illustrated in FIG. 22A, “CustomerDatabase.db” file is relocated on Tier0 in the file usage state table 111 after the relocation, and numerical values have changed accordingly compared with the file usage state table 111 before the relocation (FIG. 5).

As illustrated in FIG. 22B, “CustomerDatabse.db” file is relocated on the drive higher in performance compared with the storage usage state table 150 before the relocation. Consequently, the used capacity rate and the IOPS of the SSD increase, and the capacity usage rate and the IOPS of the SAS drive decrease. The requirement for the access performance of the files is more properly satisfied by the file relocation, resulting in an increase in the usage rate of the storage system 120 in this way.

FIG. 22C is an example of the calculation result of the operation efficiency E after the file relocation. The result of calculation of the operation efficiency E using the file usage state table 111 (FIG. 22A) and the storage usage state table 150 (FIG. 22B) after the file relocation is illustrated. Compared with the operation efficiency E before the file relocation illustrated in FIG. 12, the value of the operation efficiency E increases. The management terminal 160 may display the information on the table and the value of the operation efficiency to the administrator. As a result, the administrator can confirm the increase in the operation efficiency by the file relocation.

A description is now given of a change of parameters by the user feedback. A description is given of two examples of methods of changing parameters in response to an input by the administrator in the following. One method updates the weight parameters (refer to the weight parameter table 1500 in FIG. 15) in response to an instruction to change the capacity usage rate of a drive by the administrator. The other method updates weight coefficients (hereinafter, policy item coefficients) in accordance with an allocation destination change instruction to a file by the administrator.

As illustrated in the flowchart of FIG. 3, the system determines the relocation destination candidates of a file by using the parameters updated by the user feedback. As a result, administrator-specific finely-customized relocation control is enabled, and relocation destination candidates suitable to a state requested by the administrator can be more properly selected.

A description is first given of an input method of the user feedback by the administrator referring to FIG. 23 and FIG. 24. FIG. 23 illustrates a display example of a file/storage usage state chart. The management terminal 160 displays this image on the display apparatus. This image allows the administrator to view the allocation of the files and the usage state of the storage system 120. A drive usage rate chart 2401 illustrates a bar chart for the capacity usage rates of the drive types. A file allocation list 2402 illustrates information on the files and a list of allocation destinations.

FIG. 24 illustrates a method of inputting a feedback by the administrator to the information displayed in the file/storage usage state chart. The administrator can instruct a feedback to the system by inputting a state of the drive usage rate after a change on the drive usage rate chart 2401 by using the input device of the management terminal 160.

The example illustrated in FIG. 24 represents a state in which an input is carried out to increase the capacity usage rate of the SSD. The example illustrated in FIG. 24 further represents a state in which an input is made to migrate the file “ProductIntroduction.ppt” from Tier2 to Tier1 in the file allocation list 2402. The administrator instructs the system to reflect the input change by depressing a feedback reflection button by the input device of the management terminal 160. The input information by the administrator is transferred from the management terminal 160 to the file server 100.

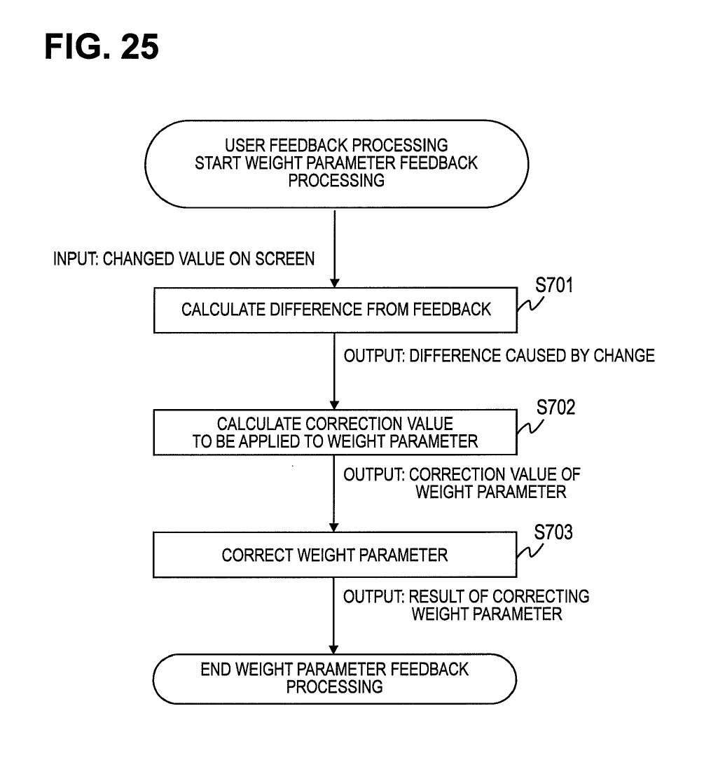

FIG. 25 illustrates a flow of a feedback to the weight parameter in accordance with a change in a drive usage rate (capacity usage rate of the drive) by the administrator on the management terminal 160. This processing corresponds to Step S102 in the flowchart of FIG. 3. The feedback processing program 109 reflects the user feedback of the drive usage rate illustrated in FIG. 24 to the weight parameter table 1500.

In the flowchart of FIG. 25, the feedback processing program 109 calculates a difference in change of the capacity usage rate of a selected drive from an input by the administrator (S701). In the example illustrated in FIG. 24, the capacity usage rate of the SSD is changed. The feedback processing program 109 calculates a correction value to the weight parameters from the difference in change (S702). The feedback processing program 109 updates the weight parameters in the weight parameter table 1500 by using the calculated correction value (S703).

The calculation of the correction value (S702) is carried out based on the following function, for example. In the function, V[Tier0] is a difference in the usage capacity rate of the SSD, W[Tier0,Tier[i]] is a weight parameter, M[Tier0,Tier[i]] is a correction value to W[Tier0,Tier[i]], L[Tieri] is a normalized correction value to W[Tier0,Tier[i]], and UW[Tier0,Tier[i]] is an updated value of W[Tier0,Tier[i]].

V[Tier0]=SSD change value−SSD current value

M[Tier0,Tier[i]]=W[Tier0,Tier[i]]×(1+V[Tier0])

L[Tier[i]]=MIN(10,M[Tier0,Tier[i]])/M[Tier0,Tier[i]]

UW[Tier0,Tier[i]]=W[Tier0,Tier[i]]×L[Tier[i]]

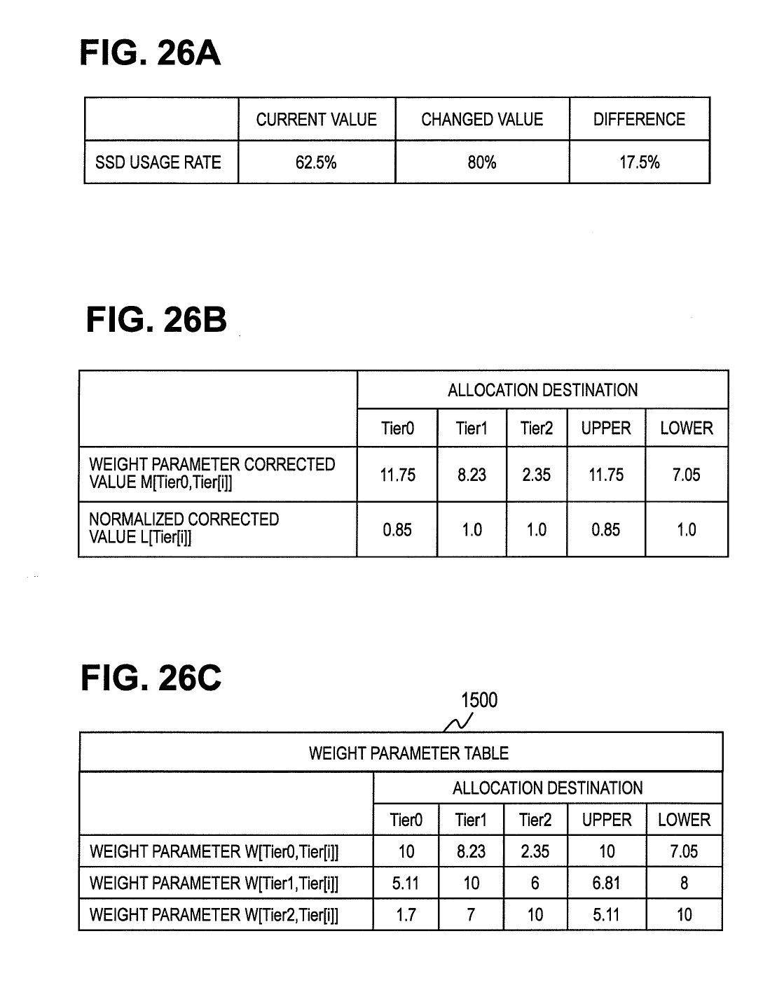

FIG. 26A illustrates an example of a feedback input value for a drive usage rate by the administrator. Similarly to the example of FIG. 24, the capacity usage rate of the SSD is changed from 62.5% to 80%. The calculation result in Step S701 in the flowchart of FIG. 25 is 17.5%.

FIG. 26B illustrates an example of feedback calculation parameters. The correction values M[Tier0,Tier[i]] of the weight parameters W[Tier0,Tier[i]], and the normalized correction values L[Tier[i]] are illustrated. The values in the weight parameter table 1500 illustrated in FIG. 15 are used for the weight parameters W[Tier0,Tier[i]] in the calculation. It should be noted that intermediate results in the calculation are stored in the calculation result storage area 114. The same holds true for the following calculation.

FIG. 26C illustrates an example of the parameter table 1500 to which a user feedback is reflected. The update values UW[Tier0,Tier[i]] calculated based on the above-mentioned function are stored in the row of the weight parameter W[Tier0,Tier[i]] of Tier0.

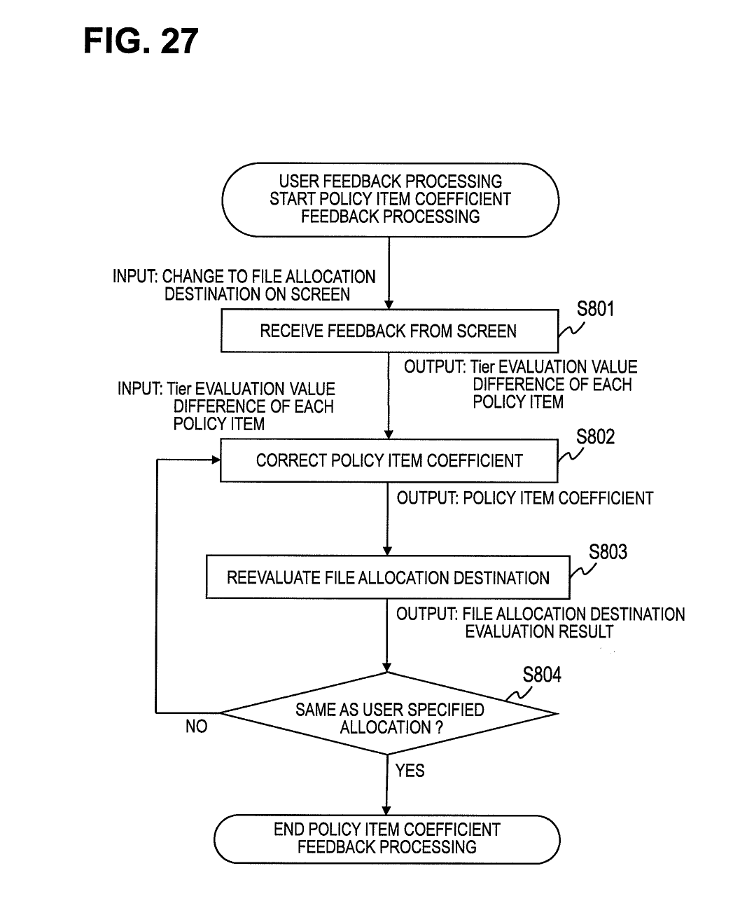

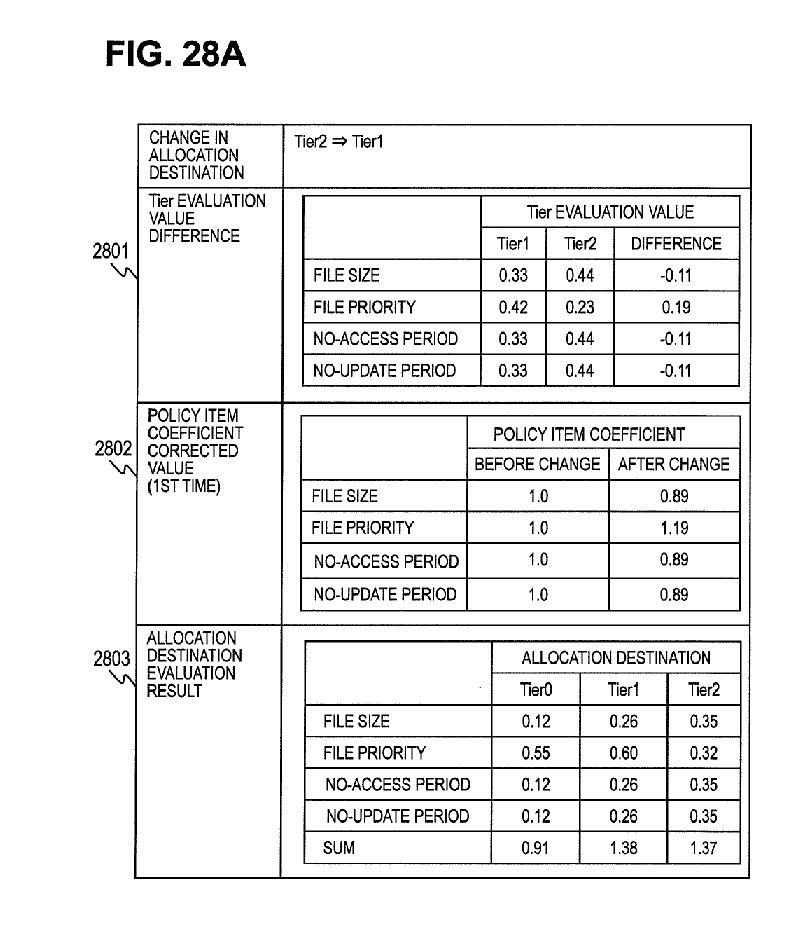

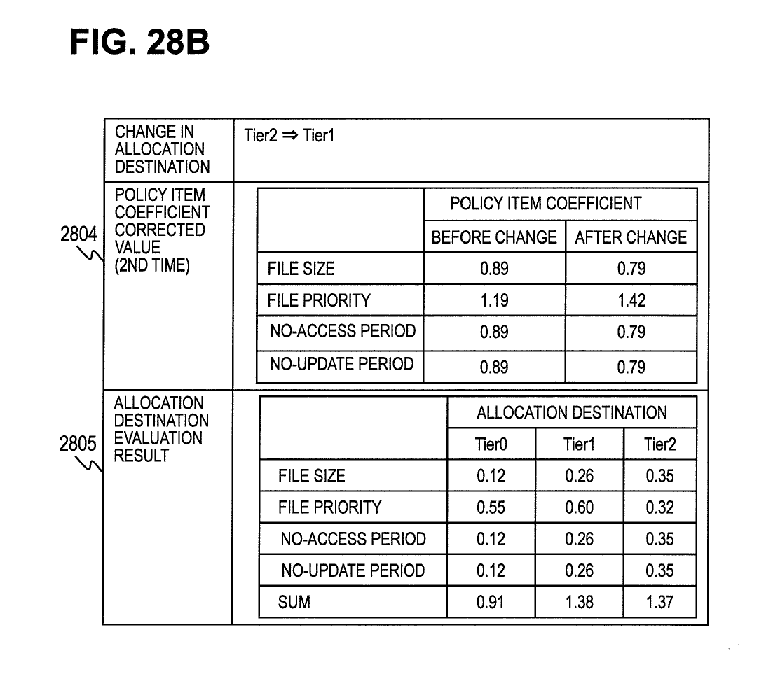

A description is now given of a flow of the feedback processing for a change in the file allocation list 2402 referring to a flowchart of FIG. 27 and a calculation progress charts in FIGS. 28A and 28B. The feedback processing program 109 updates the policy item coefficients in response to a change in the allocation destination tier of a file by the administrator.

The policy item coefficients are the weight coefficients to the operation policy items in the relocation control table 112 illustrated in FIG. 17, and are parameters (weight parameters) for determining which policy items are regarded as important. In processing before the above-mentioned feedback, all the policy item coefficients are set to 1 (initial value). The policy item coefficients are stored in the parameter table 115.

As illustrated in FIG. 27, the feedback processing program 109 receives a change to the file allocation list 2401, and calculates differences in Tier evaluation values of policy items conditions of which the selected file satisfies (of policy items with which the selected file is associated) (S801). A section 2801 of FIG. 28A illustrates changes and differences in Tier evaluation values of relating policy items as a result of a change in the allocation destination of the file “ProductIntroduction.ppt” from Tier2 to Tier1. The values of the Tier evaluation values follow the relocation control table 112.

The feedback processing program 109 then corrects (updates) the policy item coefficients by using the calculated differences of the Tier evaluation values (S802). The correction is carried out based on the following function, for example.

Policy item coefficient value=Policy item coefficient value+Tier evaluation value difference

The Tier evaluation value difference is the difference in the Tier evaluation value between before and after the change in the file allocation destination by the user calculated in Step S801. In FIG. 28A, a section 2802 illustrates a correction result of the policy item coefficients.

The feedback processing program 109 then reevaluates the allocation destination tiers of the file of interest (“ProductIntroduction.ppt”) based on the corrected policy item coefficients (S803). This method is the same as the method described referring to FIGS. 18 and 19. A section 2803 of FIG. 28A illustrates this evaluation result.

The feedback processing program 109 determines whether an allocation destination of the file of interest (“ProductIntroduction.ppt”) acquired by the evaluation result calculated in Step S803 coincides with the allocation destination specified by the user (S804). When the allocation destinations coincide with each other (YES in S804), the flow ends, and the update values of the policy item coefficients are determined. When the allocation destinations do not coincide with each other (NO in S804), the feedback processing program 109 returns to Step S802.

In this example, the allocation destination candidate represented by the allocation evaluation result of the first loop does not coincide with the tier after the change by the user (Tier 1). As illustrated in the section 2803 of FIG. 28A, the sum of the evaluation values of Tier2 is the largest in the evaluation result of the first loop.

The feedback processing program 109 performs the second loop. A section 2804 of FIG. 28B illustrates a correction result of the policy item coefficients by the second loop, and a section 2805 illustrates an allocation destination evaluation result by the second loop. The sum of the evaluation values for Tier1 is the largest in the allocation destination evaluation result by the second loop. This evaluation result indicates Tier1, which is the allocation destination specified by the user, as the allocation destination candidate, and hence the feedback program 109 finishes this flow. The update values by the second loop are determined values of the policy item coefficients.

In the above-mentioned example, the updates of the policy item coefficients by the change in the allocation destination of one file are applied to the policy item coefficients of all the files. The system may manage and use the policy item coefficients for each of the files or each of file groups, and updates of the policy item coefficients of a specific file may be limited to the file itself or a group thereof.

The detailed description has been given of this invention referring to the drawings, but this invention is not limited to this specific configuration, and includes various variations and equivalent configurations within the spirit of the accompanying claims. For example, the above-mentioned function for the file relocation is an example, and the relocation destination candidates for the file may be determined based on another function. The evaluation values of the tiers of the relocation destination candidates may be calculated without using the operation policy.

In the above-mentioned configuration example, the file server 100 evaluates relocation destination candidates of a file, but a different apparatus in the computer system, such as the storage management computer 140 may execute the processing carried out by the file server 100. A part of the processing carried out by the file server 100 may be carried out by other apparatus. The computer system for carrying out the file management may include one or more computers. The file server may automatically relocate a file to a selected relocation destination tier candidate without the input of the administrator.

The programs may be partially or entirely realized by dedicated hardware. The programs can be installed on the computers by a program distribution server or a non-transitory computer-readable storage medium, and can be stored in a non-volatile storage device of the computers. The information used in this embodiment may be represented by any data structures. For example, the information may be represented by data structures such as a table, a list, and a DB. Moreover, the representations such as identification information, the identifiers, the names, and the IDs are interchangeable with one another.

What is claimed is:

1. A computer system comprising a processor and a storage device for managing a plurality of real file systems and a virtual file system virtualizing the plurality of real file systems to control relocation of a file in the virtual file system, a plurality of volumes different in access performance provided by a storage system being assigned to the plurality of real file systems, the plurality of real file systems belonging to a plurality of tiers different in access performance, wherein:
the storage device stores file usage state information representing usage states of a plurality of files in the virtual file system;
the storage device stores storage usage state information representing a usage state of the storage system;
the processor generates control information for associating characteristics of files with evaluation values of the plurality of tiers using the file usage state information and the storage usage state information; and
the processor determines an evaluation value for each of one or more relocation destination tier candidates of a first file in the virtual file system based a characteristic of the first file and the control information.

2. A computer system according to claim 1, wherein:
the processor calculates a first index representing access performance of the plurality of files by referring to the file usage state information;
the processor calculates a second index representing a usage state of storage drives providing volumes in the storage system by referring to the storage usage state information; and
the processor generates the control information by using the first index and the second index.

3. A computer system according to claim 2, wherein:
the storage device stores policy information prescribing a policy for associating characteristics of files with specified relocation destination tiers for determining file relocation destination tier candidates; and
the processor generates the control information from the policy information by using the file usage state information and the storage usage state information.

4. A computer system according to claim 3, wherein:
the storage device stores weight parameters of the plurality of tiers for each of the specified relocation destination tiers;
the processor uses the first index and the second index to calculate a third index representing an operation efficiency of the storage system for the virtual file system and increasing with the first index and the second index; and
the processor determines the evaluation values of the plurality of tiers for each of the specified relocation destination tiers by using the weight parameters and the third index.

5. A computer system according to claim 1, wherein:
the processor determines evaluation values of characteristic items of the first file for each of the one or more relocation destination tier candidates; and
the processor determines the evaluation of each of the one or more relocation destination tier candidates from the evaluation values of the characteristic items.

6. A computer system according to claim 1, further comprising a display apparatus,
wherein the display apparatus displays an evaluation result of the one or more relocation destination candidates of the first file.

7. A computer system according to claim 1, wherein the processor selects a relocation destination tier candidate highest in the evaluation value as a relocation destination of the first file.

8. A computer system according to claim 1, wherein:
the processor receives a change request for allocation of the plurality of files or the usage state of the storage system; and
the processor updates the control information in response to the change request.

9. A computer system according to claim 2, wherein the second index is an index of a usage state of a storage drive type of highest performance in the storage system.

10. A computer system according to claim 1, wherein the processor determines the evaluation value of each of the one or more relocation destination tier candidates of the first file by using a ratio of number of files on each of the plurality of tiers on a path storing the first file.

11. A file management method performed by a computer system including a storage system providing a plurality of volumes different in access performance and a file server computer managing a plurality of real file systems and a virtual file system for virtualizing the plurality of real file systems, the plurality of volumes being assigned to the virtual file system, the virtual file system belonging to a plurality of tiers different in access performance, the file management method comprising:
acquiring file usage state information representing usage states of a plurality of files in the virtual file system;
acquiring storage usage state information representing a usage state of the storage system;
generating control information for associating characteristics of files with evaluation values of the plurality of tiers using the file usage state information and the storage usage state information; and
determining an evaluation value for each of one or more relocation destination tier candidates of a first file in the virtual file system based on a characteristic of the first file and the control information.

12. A file management method according to claim 11, wherein the generating of the control information comprises:
calculating a first index representing access performance of the plurality of files by referring to the file usage state information;
calculating a second index representing a usage state of storage drives providing volumes in the storage system by referring to the storage usage state information; and
generating the control information by using the first index and the second index.

13. A file management method according to claim 11, wherein the generating of the control information comprises generating the control information from policy information prescribing a policy for associating characteristics of files with specified relocation destination tiers for determining file relocation destination tier candidates by using the file usage state information and the storage usage state information.

14. A computer-readable non-transitory storage medium containing program codes, the program codes controlling a computer system to carry out a method of controlling relocation of a file in a virtual file system, the computer system managing a plurality of real file systems and the virtual file system virtualizing the plurality of real file systems, a plurality of volumes different in access performance provided by a storage system being assigned to the plurality of real file systems, the plurality of real file systems belonging to a plurality of tiers different in access performance, the method comprising:
collecting file usage state information representing usage states of a plurality of files in the virtual file system;
collecting storage usage state information representing a usage state of the storage system;
generating control information for associating characteristics of files with evaluation values of the plurality of tiers using the file usage state information and the storage usage state information; and
determining an evaluation value for each of one or more relocation destination tier candidates of a first file in the virtual file system based on a characteristic of the first file and the control information.
